(19) United States
(12) Patent Application Publication
(10) Pub. No.: US 2024/0214706 A1
(43) Pub. Date: Jun. 27, 2024

(54) PHOTODETECTOR, PHOTODETECTION SYSTEM, AND PHOTODETECTION METHOD

(71) Applicant: SONY SEMICONDUCTOR SOLUTIONS CORPORATION, KANAGAWA (JP)

(72) Inventors: MOTOHARU FUJII, KANAGAWA (JP); RYOTA WATANABE, KANAGAWA (JP); MASAHIRO HOSOYA, KANAGAWA (JP)

(21) Appl. No.: 18/556,994

(22) PCT Filed: Feb. 2, 2022
(86) PCT No.: PCT/JP2022/004027

§ 371 Date: Oct. 24, 2023

(30) Foreign Application Priority Data
May 17, 2021 (JP) 2021-083436

(51) Int. Cl. H04N 25/772; G01S 7/481; G01S 17/894

(52) U.S. Cl. CPC H04N 25/772; G01S 7/481; G01S 17/894

(57) ABSTRACT

A photodetector of the disclosure includes: first and second light-receiving pixels arranged side by side in a first direction; first and second signal lines extending in a second direction and coupled to the first light-receiving pixel; third and fourth signal lines extending in the second direction and coupled to the second light-receiving pixel; a first control line coupled to the first light-receiving pixel and a second control line coupled to the second light-receiving pixel and extending in the first direction; and a first control circuit. Gates of first and second control transistors in the first and second light-receiving pixels are respectively coupled to the first and second control lines. First and second output circuits in the first light-receiving pixel are respectively coupled to the first and second signal lines. First and second output circuits in the second light-receiving pixel are respectively coupled to the third and fourth signal lines.

### TECHNICAL FIELD

The present disclosure relates to a photodetector, a photodetection system, and a photodetection method that detect light.

### BACKGROUND ART

To measure a distance to a detection target, a time-of-flight (ToF) method is often used. In the ToF method, light is emitted, and reflected light reflected by the detection target is detected. In the ToF method, a time difference between a timing of emitting light and a timing of detecting reflected light is then measured to measure a distance to the detection target (for example, PTL 1).

### CITATION LIST

### Patent Literature

PTL 1: Japanese Unexamined Patent Application Publication No. JP 2021-50987

### SUMMARY OF THE INVENTION

Incidentally, what is demanded for a photodetector is a reduced circuit area, and what is expected is a further reduced circuit area.

It is desirable to provide a photodetector, a photodetection system, and a photodetection method that make it possible to reduce a circuit area.

A photodetector according to an embodiment of the present disclosure includes: a first light-receiving pixel and a second light-receiving pixel; a first signal line and a second signal line; a third signal line and a fourth signal line; a first control line and a second control line; and a first control circuit. The first light-receiving pixel and the second light-receiving pixel are arranged side by side in a first direction. The first signal line and the second signal line extend in a second direction that differs from the first direction and are coupled to the first light-receiving pixel. The third signal line and the fourth signal line extend in the second direction and are coupled to the second light-receiving pixel. The first control line extends in the first direction and is coupled to the first light-receiving pixel. The second control line extends in the first direction and is coupled to the second light-receiving pixel. The first control circuit is configured to control operations of the first light-receiving pixel and the second light-receiving pixel via the first control line and the second control line. The first light-receiving pixel and the second light-receiving pixel each include: a light-receiving element; a first accumulation element and a second accumulation element; a first transfer transistor; a second transfer transistor; a first control transistor; a second control transistor; a first output circuit; and a second output circuit. The light-receiving element is configured to generate electric charge on the basis of light. The first accumulation element and the second accumulation element are configured to accumulate electric charge. The first transfer transistor is configured to couple the light-receiving element and the first accumulation element to each other upon coming into an on state. The second transfer transistor is configured to couple the light-receiving element and the second accumulation element to each other upon coming into an on state. The first control transistor is supplied to be configured to apply a predetermined voltage to the first accumulation element upon coming into an on state. The second control transistor is supplied to be configured to apply a predetermined voltage to the second accumulation element upon coming into an on state. The first output circuit is configured to output a voltage corresponding to a voltage in the first accumulation element. The second output circuit is configured to output a voltage corresponding to a voltage in the second accumulation element. Gates of the first control transistor and the second control transistor in the first light-receiving pixel are coupled to the first control line, and the first output circuit and the second output circuit in the first light-receiving pixel are respectively coupled to the first signal line and the second signal line. Gates of the first control transistor and the second control transistor in the second light-receiving pixel are coupled to the second control line, and the first output circuit and the second output circuit in the second light-receiving pixel are respectively coupled to the third signal line and the fourth signal line.

A photodetection system according to an embodiment of the present disclosure includes: a light-emitting section; a first light-receiving pixel and a second light-receiving pixel; a first signal line and a second signal line; a third signal line and a fourth signal line; a first control line and a second control line; and a first control circuit. The light-emitting section is configured to emit light pulses. The first light-receiving pixel and the second light-receiving pixel are arranged side by side in a first direction, and are each configured to detect a light pulse reflected by a detection target among the light pulses emitted from the light-emitting section. The first signal line and the second signal line extend in a second direction that differs from the first direction and are coupled to the first light-receiving pixel. The third signal line and the fourth signal line extend in the second direction and are coupled to the second light-receiving pixel. The first control line extends in the first direction and is coupled to the first light-receiving pixel. The second control line extends in the first direction and is coupled to the second light-receiving pixel. The first control circuit is configured to control operations of the first light-receiving pixel and the second light-receiving pixel via the first control line and the second control line. The first light-receiving pixel and the second light-receiving pixel each include: a light-receiving element; a first accumulation element and a second accumulation element; a first transfer transistor; a second transfer transistor; a first control transistor; a second control transistor; a first output circuit; and a second output circuit. The light-receiving element is configured to generate electric charge on the basis of light. The first accumulation element and the second accumulation element are configured to accumulate electric charge. The first transfer transistor is configured to couple the light-receiving element and the first accumulation element to each other upon coming into an on state. The second transfer transistor is configured to couple the light-receiving element and the second accumulation element to each other upon coming into an on state. The first control transistor is supplied to be configured to apply a predetermined voltage to the first accumulation element upon coming into an on state. The second control transistor is supplied to be configured to apply a predetermined voltage to the second accumulation element upon coming into an on state. The first output circuit is configured to output a voltage corresponding to a voltage in the first accumulation element. The second output circuit is configured to output a voltage corresponding to a voltage in the second accumulation element. Gates of the first control transistor and the second control transistor in the first light-receiving pixel are coupled to the first control line, and the first output circuit and the second output circuit in the first light-receiving pixel are respectively coupled to the first signal line and the second signal line. Gates of the first control transistor and the second control transistor in the second light-receiving pixel are coupled to the second control line, and the first output circuit and the second output circuit in the second light-receiving pixel are respectively coupled to the third signal line and the fourth signal line.

A photodetection method according to an embodiment of the present disclosure includes: bringing, in a first period, a first control transistor and a second control transistor in a first light-receiving pixel each into an on state in a photodetector; and bringing, in a second period, a first control transistor and a second control transistor in a second light-receiving pixel each into an on state in the photodetector, the photodetector including the first light-receiving pixel and the second light-receiving pixel arranged side by side in a first direction, a first signal line and a second signal line extending in a second direction that differs from the first direction and being coupled to the first light-receiving pixel, a third signal line and a fourth signal line extending in the second direction and being coupled to the second light-receiving pixel, and a first control line and a second control line extending in the first direction, the first control line being coupled to the first light-receiving pixel, the second control line being coupled to the second light-receiving pixel, the first light-receiving pixel and the second light-receiving pixel each including a light-receiving element configured to generate electric charge on a basis of light, a first accumulation element and a second accumulation element that are configured to accumulate the electric charge, a first transfer transistor configured to couple the light-receiving element and the first accumulation element to each other upon coming into an on state, a second transfer transistor configured to couple the light-receiving element and the second accumulation element to each other upon coming into an on state, the first control transistor configured to apply a predetermined voltage to the first accumulation element upon coming into an on state, the second control transistor configured to apply the predetermined voltage to the second accumulation element upon coming into an on state, a first output circuit configured to output a voltage corresponding to a voltage in the first accumulation element, and a second output circuit configured to output a voltage corresponding to a voltage in the second accumulation element, in which gates of the first control transistor and the second control transistor in the first light-receiving pixel are coupled to the first control line, the first output circuit and the second output circuit in the first light-receiving pixel are respectively coupled to the first signal line and the second signal line, gates of the first control transistor and the second control transistor in the second light-receiving pixel are coupled to the second control line, and the first output circuit and the second output circuit in the second light-receiving pixel are respectively coupled to the third signal line and the fourth signal line.

In the photodetector, the photodetection system, and the photodetection method according to the embodiments of the present disclosure, electric charge is generated by the light-receiving element in each of the first light-receiving pixel and the second light-receiving pixel. The electric charge is accumulated in the first accumulation element as the first transfer transistor comes into an on state, and accumulated in the second accumulation element as the second transfer transistor comes into an on state. As the first control transistor comes into an on state, a predetermined voltage is applied to the first accumulation element. As the second control transistor comes into an on state, a predetermined voltage is applied to the second accumulation element. The first output circuit outputs a voltage corresponding to a voltage in the first accumulation element, and the second output circuit outputs a voltage corresponding to a voltage in the second accumulation element. The first light-receiving pixel and the second light-receiving pixel are arranged side by side in the first direction. The first signal line and the second signal line extend in the second direction and are coupled to the first light-receiving pixel. The third signal line and the fourth signal line extend in the second direction and are coupled to the second light-receiving pixel. The first control line extends in the first direction and is coupled to the first light-receiving pixel. The second control line extends in the first direction and is coupled to the second light-receiving pixel. Operations of the first light-receiving pixel and the second light-receiving pixel are controlled by the first control circuit via the first control line and the second control line. The gates of the first control transistor and the second control transistor in the first light-receiving pixel are coupled to the first control line, and the first output circuit and the second output circuit in the first light-receiving pixel are respectively coupled to the first signal line and the second signal line. The gates of the first control transistor and the second control transistor in the second light-receiving pixel are coupled to the second control line, and the first output circuit and the second output circuit in the second light-receiving pixel are respectively coupled to the third signal line and the fourth signal line.

### BRIEF DESCRIPTION OF THE DRAWINGS

FIG. 1 is a block diagram illustrating a configuration example of a photodetection system according to an embodiment of the present disclosure.

FIG. 2 is a block diagram illustrating a configuration example of a photodetection unit according to a first embodiment.

FIG. 3 is an explanatory diagram illustrating a configuration example of a pixel array illustrated in FIG. 2.

FIG. 4 is a circuit diagram illustrating a configuration example of light-receiving pixels illustrated in FIG. 3.

FIG. 5 is a block diagram illustrating a configuration example of a readout section illustrated in FIG. 2.

FIG. 6 is an explanatory diagram illustrating an implementation example of the photodetection unit illustrated in FIG. 2.

FIG. 7 is an explanatory diagram illustrating an operation example of the photodetection system illustrated in FIG. 1.

FIG. 8 is a timing waveform diagram illustrating an operation example of the photodetection system according to the first embodiment.

FIG. 9 is a timing waveform diagram illustrating an example of exposure operation in the photodetection system illustrated in FIG. 1.

FIG. 10A is an explanatory diagram illustrating an operation state of a switch section illustrated in FIG. 5.

FIG. 10B is an explanatory diagram illustrating another operation state of the switch section illustrated in FIG. 5.

FIG. 11 is a timing waveform diagram illustrating an example of the exposure operation in the photodetection system illustrated in FIG. 1.

FIG. 12 is an explanatory diagram illustrating an operation example of a processing section illustrated in FIG. 2.

FIG. 13 is an explanatory diagram illustrating a configuration example of a pixel array according to a modification example of the first embodiment.

FIG. 14 is a circuit diagram illustrating a configuration example of light-receiving pixels illustrated in FIG. 13.

FIG. 15A is an explanatory diagram illustrating an operation example of a processing section according to another modification example of the first embodiment.

FIG. 15B is another explanatory diagram illustrating the operation example of the processing section according to the other modification example of the first embodiment.

FIG. 15C is still another explanatory diagram illustrating the operation example of the processing section according to the other modification example of the first embodiment.

FIG. 16 is a block diagram illustrating a configuration example of a photodetection unit according to a second embodiment.

FIG. 17 is a timing waveform diagram illustrating an operation example of a photodetection system according to the second embodiment.

FIG. 18 is an explanatory diagram illustrating an operation state of a switch section according to the second embodiment.

FIG. 19 is a block diagram illustrating a configuration example of a photodetection unit according to a third embodiment.

FIG. 20 is an explanatory diagram illustrating a configuration example of a pixel array illustrated in FIG. 19.

FIG. 21 is a circuit diagram illustrating a configuration example of light-receiving pixels illustrated in FIG. 20.

FIG. 22 is a block diagram illustrating a configuration example of a readout section illustrated in FIG. 19.

FIG. 23 is an explanatory diagram illustrating a configuration example of a pixel array according to a modification example of the third embodiment.

FIG. 24 is a circuit diagram illustrating a configuration example of light-receiving pixels illustrated in FIG. 23.

FIG. 25 is a block diagram depicting an example of schematic configuration of a vehicle control system.

FIG. 26 is a diagram of assistance in explaining an example of installation positions of an outside-vehicle information detecting section and an imaging section.

### MODES FOR CARRYING OUT THE INVENTION

In the following, some embodiments of the present disclosure are described in detail with reference to the drawings. It is to be noted that the description is given in the following order.

### 1. First Embodiment

### 2. Second Embodiment

### 3. Third Embodiment

### 4. Example of Application to Mobile Body

### 1. First Embodiment

### Configuration Example

FIG. 1 illustrates a configuration example of a photodetection system according to an embodiment (a photodetection system 1). The photodetection system 1 is a ToF sensor and is configured to emit light toward a detection target, and to detect reflected light reflected by the detection target. The photodetection system 1 includes a light-emitting section 11, an optical system 12, a photodetection unit 20, and a control section 14.

The light-emitting section 11 is configured to emit light pulse L0 toward a detection target on the basis of an instruction from the control section 14. The light-emitting section 11 performs light-emitting operation where light emission and non-light emission are alternately repeated on the basis of an instruction from the control section 14 to emit the light pulse L0. The light-emitting section 11 includes a light source that emits infrared light, for example. The light source includes a laser light source or light emitting diodes (LEDs), for example.

The optical system 12 includes a lens that forms an image on a light-receiving surface S of the photodetection unit 20. The light pulse emitted from the light-emitting section 11 and reflected by the detection target (reflected light pulse L1) enters the optical system 12.

The photodetection unit 20 is configured to detect the reflected light pulse L1 on the basis of an instruction from the control section 14. The photodetection unit 20 then generates a distance image on the basis of a result of detection, and outputs image data of the generated distance image as data DT.

The control section 14 is configured to supply control signals to the light-emitting section 11 and the photodetection unit 20 and control operation thereof to control operation of the photodetection system 1.

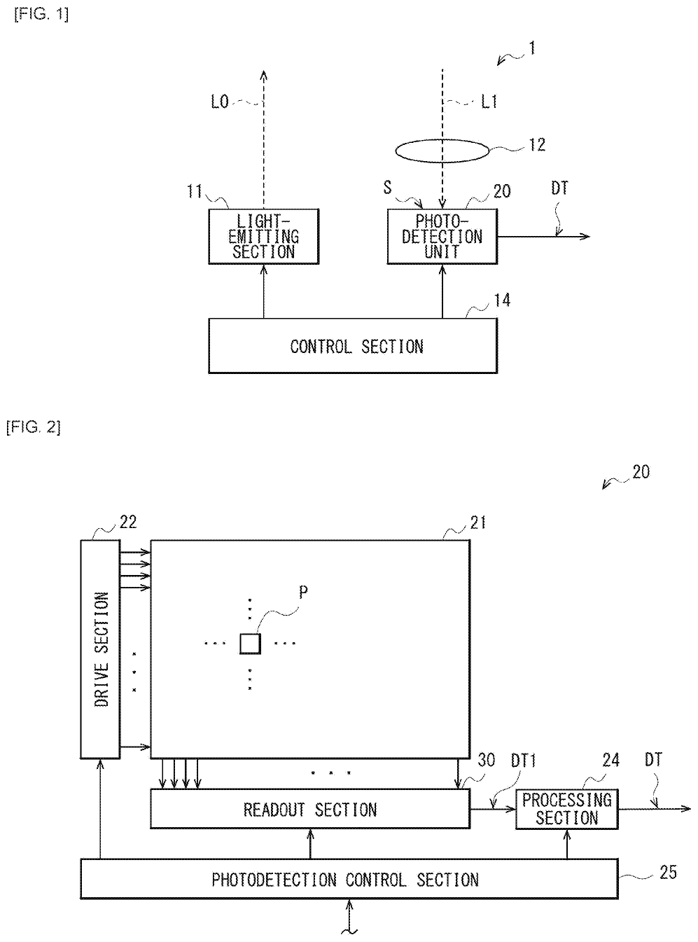

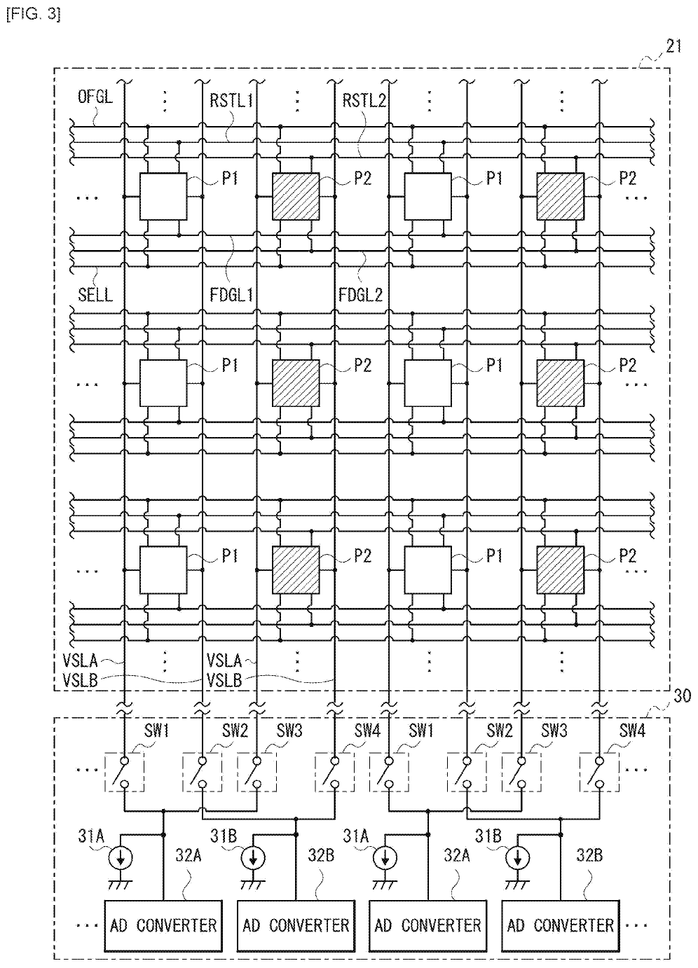

FIG. 2 illustrates a configuration example of the photodetection unit 20. The photodetection unit 20 includes a pixel array 21, a drive section 22, a readout section 30, a processing section 24, and a photodetection control section 25.

In the pixel array 21, a plurality of light-receiving pixels P is disposed in a matrix. Each of the light-receiving pixels P outputs pixel signals SIGA and SIGB in accordance with a received light amount.

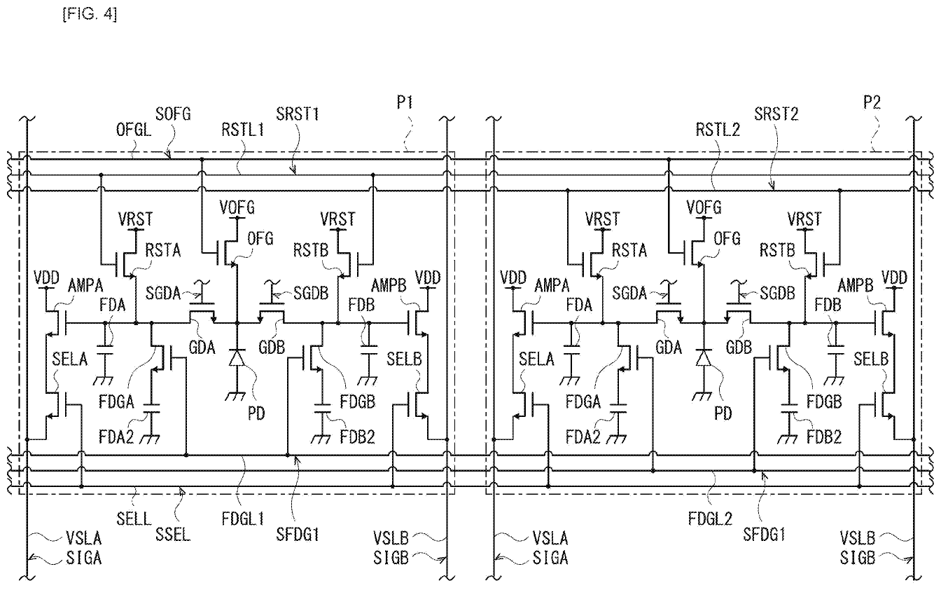

FIG. 3 illustrates a configuration example of the pixel array 21. It is to be noted that FIG. 2 further illustrates the readout section 30 in addition to the pixel array 21. The pixel array 21 includes a plurality of control lines OFGL, a plurality of control lines RSTL1, a plurality of control lines RSTL2, a plurality of control lines FDGL1, a plurality of control lines FDGL2, a plurality of control lines SELL, a plurality of signal lines VSLA, and a plurality of signal lines VSLB. The control lines OFGL, RSTL1, RSTL2, FDGL1, FDGL2, and SELL are configured to extend in a horizontal direction (a lateral direction in FIG. 3). The signal lines VSLA and VSLB are configured to extend in a vertical direction (a longitudinal direction in FIG. 3).

The plurality of light-receiving pixels P includes a plurality of light-receiving pixels P1 and a plurality of light-receiving pixels P2. FIG. 3 illustrates the light-receiving pixels P2 each in a shaded manner. The light-receiving pixels P1 are each coupled to the control lines OFGL, RSTL1, FDGL1, and SELL and the signal lines VSLA and VSLB. The light-receiving pixels P2 are each coupled to the control lines OFGL, RSTL2, FDGL2, and SELL and the signal lines VSLA and VSLB. The light-receiving pixels P1 and the light-receiving pixels P2 are alternately arranged in the horizontal direction (the lateral directions in FIG. 3), as illustrated in FIG. 3. The light-receiving pixels P1 and the light-receiving pixels P2 arranged side by side in the horizontal direction to form one row correspond to a pixel line.

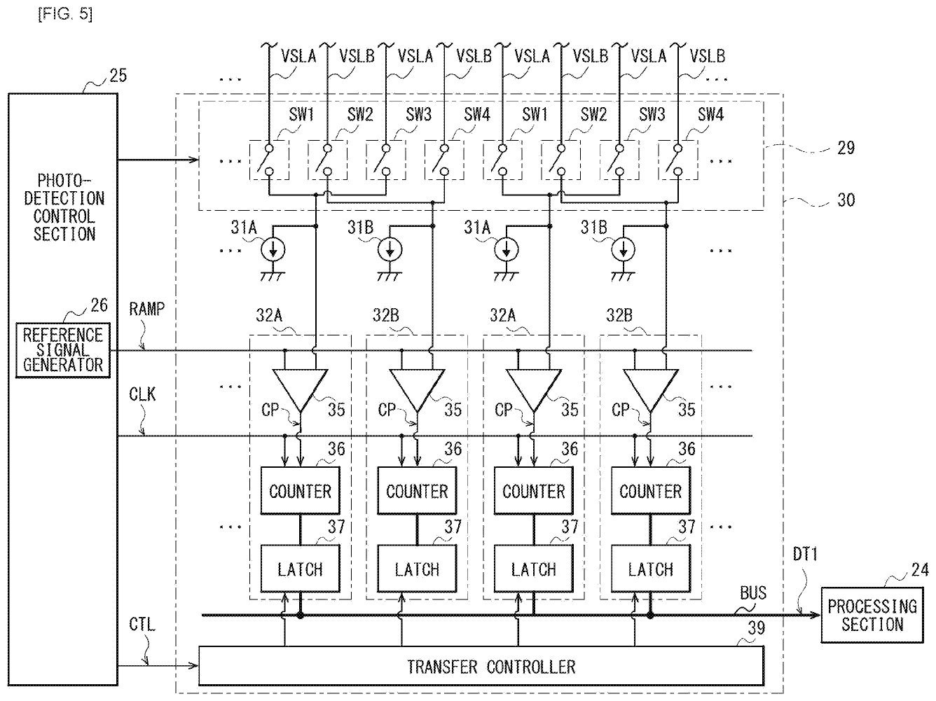

FIG. 4 illustrates a configuration example of the light-receiving pixels P. The light-receiving pixels P each include a photodiode PD, a transistor OFG, transistors GDA and GDB, floating diffusions FDA and FDB, transistors RSTA and RSTB, transistors FGDA and FGDB, floating diffusions FDA2 and FDB2, transistors AMPA and AMPB, and transistors SELA and SELB. The transistors OFG, GDA, GDB, RSTA, RSTB, FDGA, FDGB, AMPA, AMPB, SELA, and SELB are each an N-type metal oxide semiconductor (MOS) transistor, in this example.

The photodiode PD is a photoelectric conversion element that causes electric charge to occur in accordance with a received light amount. An anode of the photodiode PD is grounded, and a cathode is coupled to sources of the transistors GDA, GDB, and OFG.

A gate of the transistor OFG is coupled to the control line OFGL, a drain is supplied with a voltage VOFG, and the source is coupled to the cathode of the photodiode PD and the sources of the transistors GDA and GDB. The gate of the transistor OFG is supplied with a control signal SOFG via the control line OFGL from the drive section 22.

A gate of the transistor GDA is supplied with a control signal SGDA generated by the drive section 22, the source is coupled to the cathode of the photodiode PD and the sources of the transistors GDB and OFG, and a drain is coupled to the floating diffusion FDA, a source of the transistor RSTA, a drain of the transistor FDGA, and a gate of the transistor AMPA.

The floating diffusion FDA is configured to accumulate electric charge supplied via the transistor GDA from the photodiode PD. The floating diffusion FDA is configured by using a diffusion layer formed on a surface of a semiconductor substrate, for example. In FIG. 4, the floating diffusion FDA is indicated by using a symbol of a capacitor.

A drain of the transistor RSTA is supplied with a voltage VRST, and the source is coupled to the drain of the transistor GDA, the floating diffusion FDA, the drain of the transistor FDGA, and the gate of the transistor AMPA. A gate of the transistor RSTA in the light-receiving pixel P1 is coupled to the control line RSTL1. The gate of the transistor RSTA in the light-receiving pixel P1 is supplied with a control signal SRST1 via the control line RSTL1 from the drive section 22. The gate of the transistor RSTA in the light-receiving pixel P2 is coupled to the control line RSTL2. The gate of the transistor RSTA in the light-receiving pixel P2 is supplied with a control signal SRST2 via the control line RSTL2 from the drive section 22.

The drain of the transistor FDGA is coupled to the drain of the transistor GDA, the floating diffusion FDA, the source of the transistor RSTA, and the gate of the transistor AMPA, and a source is coupled to the floating diffusion FDA2. A gate of the transistor FDGA in the light-receiving pixel P1 is coupled to the control line FDGL1. The gate of the transistor FDGA in the light-receiving pixel P1 is supplied with the control signal SFDG1 via the control line FDGL1 from the drive section 22. The gate of the transistor FDGA in the light-receiving pixel P2 is coupled to the control line FDGL2. The gate of the transistor FDGA in the light-receiving pixel P2 is supplied with a control signal SFDG2 via the control line FDGL2 from the drive section 22.

The floating diffusion FDA2 is configured to accumulate electric charge supplied via the transistors GDA and FDGA from the photodiode PD. Similarly to the floating diffusion FDA, the floating diffusion FDA2 is configured by using a diffusion layer formed on a surface of a semiconductor substrate, for example.

The gate of the transistor AMPA is coupled to the drain of the transistor GDA, the floating diffusion FDA, the source of the transistor RSTA, the drain of the transistor FDGA, a drain is supplied with a power supply voltage VDD, and a source is coupled to a drain of the transistor SELA.

A gate of the transistor SELA is coupled to the control line SELL, the drain is coupled to the source of the transistor AMPA, and a source is coupled to the signal line VSLA. The gate of the transistor SELA is supplied with a control signal SSEL via the control line SELL from the drive section 22.

A gate of the transistor GDB is supplied with a control signal SGDB generated by the drive section 22, the source is coupled to the cathode of the photodiode PD and the sources of the transistors GDA and OFG, and a drain is coupled to the floating diffusion FDB, a source of the transistor RSTB, a drain of the transistor FDGB, and a gate of the transistor AMPB.

The floating diffusion FDB is configured to accumulate electric charge supplied via the transistor GDB from the photodiode PD. The floating diffusion FDB is configured by using a diffusion layer formed on a surface of a semiconductor substrate, for example.

A drain of the transistor RSTB is supplied with the voltage VRST, the source is coupled to the drain of the transistor GDB, the floating diffusion FDB, the drain of the transistor FDGB, and the gate of the transistor AMPB. A gate of the transistor RSTB in the light-receiving pixel P1 is coupled to the control line RSTL1. The gate of the transistor RSTB in the light-receiving pixel P1 is supplied with the control signal SRST1 via the control line RSTL1 from the drive section 22. The gate of the transistor RSTB in the light-receiving pixel P2 is coupled to the control line RSTL2. The gate of the transistor RSTB in the light-receiving pixel P2 is supplied with the control signal SRST2 via the control line RSTL2 from the drive section 22.

The drain of the transistor FDGB is coupled to the drain of the transistor GDB, the floating diffusion FDB, the source of the transistor RSTB, and the gate of the transistor AMPB, and a source is coupled to the floating diffusion FDB2. A gate of the transistor FDGB in the light-receiving pixel P1 is coupled to the control line FDGL1. The gate of the transistor FDGB in the light-receiving pixel P1 is supplied with the control signal SFDG1 via the control line FDGL1 from the drive section 22. The gate of the transistor FDGB in the light-receiving pixel P2 is coupled to the control line FDGL2. The gate of the transistor FDGB in the light-receiving pixel P2 is supplied with the control signal SFDG2 via the control line FDGL2 from the drive section 22.

The floating diffusion FDB2 is configured to accumulate electric charge supplied via the transistors GDB and FDGB from the photodiode PD. Similarly to the floating diffusion FDB, the floating diffusion FDB2 is configured by using a diffusion layer formed on a surface of a semiconductor substrate, for example.

The gate of the transistor AMPB is coupled to the drain of the transistor GDB, the floating diffusion FDB, the source of the transistor RSTB, and the drain of the transistor FDGB, and a drain is supplied with the power supply voltage VDD, and a source is coupled to a drain of the transistor SELB.

A gate of the transistor SELB is coupled to the control line SELL, the drain is coupled to the source of the transistor AMPB, and a source is coupled to the signal line VSLB. The gate of the transistor SELB is supplied with the control signal SSEL via the control line SELL from the drive section 22.

With this configuration, the transistor GDA and the transistor GDB are each alternately brought into an on state in the light-receiving pixel P, in exposure operation, as described later. In a case where the transistors FDGA and FDGB are each in an off state, for example, electric charge generated by the photodiode PD is selectively accumulated in the floating diffusion FDA or the floating diffusion FDB. In a case where the transistors FDGA and FDGB are each in the on state, for example, electric charge generated by the photodiode PD is selectively accumulated in the floating diffusions FDA and FDA2, or the floating diffusions FDB and FDB2.

In a case where the transistors FDGA and FDGB are each in the off state, as described above, electric charge is selectively accumulated in the floating diffusion FDA or the floating diffusion FDB. A capacity value is smaller in this case, thus making it possible to increase a conversion gain of converting electric charge into a voltage in the light-receiving pixel P. Furthermore, in a case where the transistors FDGA and FDGB are each in the off state, electric charge is selectively accumulated in the floating diffusions FDA and FDA2 or the floating diffusions FDB and FDB2. A capacity value is greater in this case, thus making it possible to reduce a conversion gain of converting electric charge into a voltage in the light-receiving pixel P.

Furthermore, the transistors SELA and SELB each come into the on state in the light-receiving pixel P in read operation. In this case, as illustrated in FIGS. 3 and 4, the source of the transistor AMPA is coupled to a constant current source 31A (described later), and the source of the transistor AMPB is coupled to a constant current source 31B (described later). Thereby, the transistors AMPA and AMPB operate as source followers. As a result, the light-receiving pixel P supplies a voltage corresponding to a voltage in the floating diffusion FDA as a pixel signal SIGA to the readout section 30, and supplies a voltage corresponding to a voltage in the floating diffusion FDB as a pixel signal SIGB to the readout section 30.

The drive section 22 (FIG. 2) is configured to drive the pluralities of light-receiving pixels P1 and P2 on the basis of an instruction from the photodetection control section 25. Specifically, the drive section 22 applies a plurality of control signals SOFG respectively to the plurality of control lines OFGL, applies a plurality of control signals SRST1 respectively to the plurality of control lines RSTL1, applies a plurality of control signals SRST2 respectively to the plurality of control lines RSTL2, applies a plurality of control signals SFDG1 respectively to the plurality of control lines FDGL1, applies a plurality of control signals SFDG2 respectively to the plurality of control lines FDGL2, and applies a plurality of control signals SSEL respectively to the plurality of control lines SELL. Furthermore, the drive section 22 supplies control signals SGDA and SGDB respectively to the pluralities of light-receiving pixels P1 and P2.

The readout section 30 is configured to perform analog-to-digital (AD) conversion on the basis of the pixel signals SIGA and SIGB supplied via the signal lines VSLA and VSLB from the pixel array 21 to generate the data DT1.

FIG. 5 illustrates a configuration example of the readout section 30. It is to be noted that FIG. 5 further illustrates the processing section 24 and the photodetection control section 25 in addition to the readout section 30. The readout section 30 includes a switch section 29, a plurality of constant current sources 31A, a plurality of constant current sources 31B, a plurality of analog-to-digital (AD) converters 32A, a plurality of AD converters 32B, and a transfer controller 39.

The switch section 29 is configured to couple the plurality of signal lines VSLA and the plurality of signal lines VSLB in the pixel array 21 respectively to the plurality of AD converters 32A and the plurality of AD converters 32B in the readout section 30 on the basis of a control signal from the photodetection control section 25. The switch section 29 includes a plurality of switches SW1, a plurality of switches SW2, a plurality of switches SW3, and a plurality of switches SW4.

As illustrated in FIG. 3, one end of the switch SW1 is coupled to the signal line VSLA coupled to the light-receiving pixel P1, and the other end is coupled to the constant current source 31A and the AD converter 32A. One end of the switch SW2 is coupled to the signal line VSLB coupled to the light-receiving pixel P1, and the other end is coupled to the constant current source 31B and the AD converter 32B. One end of the switch SW3 is coupled to the signal line VSLA coupled to the light-receiving pixel P2, and the other end is coupled to the constant current source 31A and the AD converter 32A. One end of the switch SW4 is coupled to the signal line VSLB coupled to the light-receiving pixel P2, and the other end is coupled to the constant current source 31B and the AD converter 32B.

The constant current source 31A is configured to allow a current having a predetermined current value to flow from one end to another end. One end of the constant current source 31A is coupled to the switches SW1 and SW3 and the AD converter 32A, and the other end is grounded. The constant current source 31B is configured to allow a current having a predetermined current value to flow from one end to another end. One end of the constant current source 31B is coupled to the switches SW2 and SW4 and the AD converter 32B, and the other end is grounded.

The AD converter 32A is configured to perform AD conversion on the basis of the pixel signals SIGA supplied via the switches SW1 and SW3 to generate a digital code. The AD converter 32A includes a comparator 35, a counter 36, and a latch 37.

The comparator 35 is configured to compare a reference signal RAMP and the pixel signal SIGA with each other to output a signal CP indicating a result of the comparison. The reference signal RAMP has a so-called ramp waveform where a voltage level gradually changes as time passes by in two periods (conversion periods T1 and T2) in which AD conversion is performed, as described later.

The counter 36 is configured to perform count operation of counting pulses of a clock signal CLK supplied from the photodetection control section 25 on the basis of the signal CP supplied from the comparator 35. Specifically, the counter 36 counts pulses of the clock signal CLK until the signal CP transitions in the conversion period T1 to generate a count value CNT1, and outputs the count value CNT1 as a digital code having a plurality of bits. Furthermore, the counter 36 counts pulses of the clock signal CLK until the signal CP transitions in the conversion period T2 to generate a count value CNT2, and outputs the count value CNT2 as a digital code having a plurality of bits.

The latch 37 is configured to temporarily hold a digital code supplied from the counter 36, and to output the digital code to a bus wiring line BUS on the basis of an instruction from the transfer controller 39.

The AD converter 32B is configured to perform AD conversion on the basis of the pixel signal SIGB supplied via the switches SW2 and SW4 to generate a digital code. Similarly to the AD converter 32A, the AD converter 32B includes the comparator 35, the counter 36, and the latch 37.

The transfer controller 39 is configured to control the latches 37 of the plurality of AD converters 32A and 32B to sequentially output digital codes to the bus wiring line BUS on the basis of control signals CTL supplied from the photodetection control section 25. The readout section 30 uses the bus wiring line BUS to sequentially transfer a plurality of digital codes supplied from the plurality of AD converters 32A and 32B as the data DT1 to the processing section 24.

The processing section 24 (FIGS. 2 and 5) is configured to perform signal processing to process the data DT1 on the basis of an instruction from the photodetection control section 25 to generate a distance image in which each pixel value indicates a value about a distance.

The photodetection control section 25 (FIGS. 2 and 5) is configured to supply control signals to the drive section 22, the readout section 30, and the processing section 24 to control operations of respective circuits of the drive section 22, the readout section 30, and the processing section 24 to control operation of the photodetection unit 20.

The photodetection control section 25 includes a reference signal generator 26, as illustrated in FIG. 5. The reference signal generator 26 is configured to generate the reference signal RAMP. The reference signal RAMP has a so-called ramp waveform where a voltage level gradually changes as time passes by in two periods (the conversion periods T1 and T2) in which AD conversion is performed. The reference signal generator 26 supplies the generated reference signal RAMP to the plurality of AD converters 32A and 32B in the readout section 30.

Next, implementation of the photodetection unit 20 is described herein. In the photodetection unit 20, blocks illustrated in FIG. 2 may be formed on a single semiconductor substrate or may be formed on a plurality of semiconductor substrates, for example.

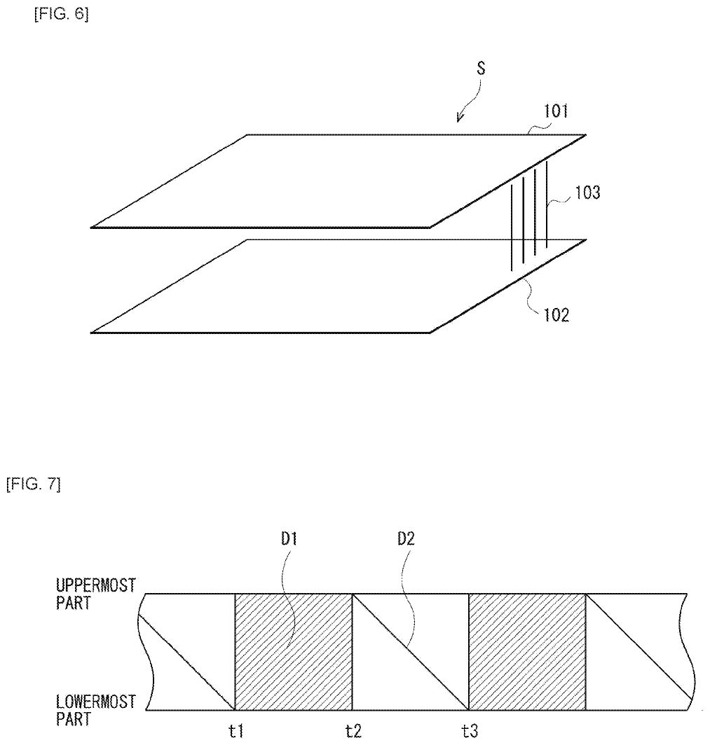

FIG. 6 illustrates an implementation example of the photodetection unit 20 in a case where the photodetection unit 20 is formed on two semiconductor substrates 101 and 102. The semiconductor substrate 101 is disposed on a side of the light-receiving surface S, of the photodetection unit 20. The semiconductor substrate 102 is disposed on a side opposite to the light-receiving surface S of the photodetection unit 20. The semiconductor substrates 101 and 102 are stacked on each other. Wiring lines in the semiconductor substrate 101 and wiring lines in the semiconductor substrate 102 are coupled to each other by wiring lines 103. For the wiring lines 103, for example, metallic bonding such as Cu—Cu can be used. The pixel array 21 is formed in the semiconductor substrate 101, for example. Furthermore, the drive section 22, the readout section 30, the processing section 24, and the photodetection control section 25 are formed in the semiconductor substrate 102.

Note herein that the light-receiving pixel P1 corresponds to a specific example of a “first light-receiving pixel” in the present disclosure. The light-receiving pixel P2 corresponds to a specific example of a “second light-receiving pixel” in the present disclosure. The signal line VSLA coupled to the light-receiving pixels P1 corresponds to a specific example of a “first signal line” in the present disclosure. The signal line VSLB coupled to the light-receiving pixels P1 corresponds to a specific example of a “second signal line” in the present disclosure. The signal line VSLA coupled to the light-receiving pixels P2 corresponds to a specific example of a “third signal line” in the present disclosure. The signal line VSLB coupled to the light-receiving pixels P2 corresponds to a specific example of a “second signal line” in the present disclosure. The control line RSTL1 corresponds to a specific example of a “first control line” in the present disclosure. The control line RSTL2 corresponds to a specific example of a “second control line” in the present disclosure. The control line FDGL1 corresponds to a specific example of a “third control line” in the present disclosure. The control line FDGL2 corresponds to a specific example of a “fourth control line” in the present disclosure. The drive section 22 corresponds to a specific example of a “first control circuit” in the present disclosure. The processing section 24 corresponds to a specific example of a “processing section” in the present disclosure. The light-emitting section 11 corresponds to a specific example of a “light-emitting section” in the present disclosure.

The photodiode PD corresponds to a specific example of a “light-receiving element” in the present disclosure. The floating diffusion FDA corresponds to a specific example of a “first accumulation element” in the present disclosure. The floating diffusion FDB corresponds to a specific example of a “second accumulation element” in the present disclosure. The floating diffusion FDA2 corresponds to a specific example of a “third accumulation element” in the present disclosure. The floating diffusion FDB2 corresponds to a specific example of a “fourth accumulation element” in the present disclosure. The transistor GDA corresponds to a specific example of a “first transfer transistor” in the present disclosure. The transistor GDB corresponds to a specific example of a “second transfer transistor” in the present disclosure. The transistor RSTA corresponds to a specific example of a “first control transistor” in the present disclosure. The transistor RSTB corresponds to a specific example of a “second control transistor” in the present disclosure. The transistor FDGA corresponds to a specific example of a “third control transistor” in the present disclosure. The transistor FDGB corresponds to a specific example of a “fourth control transistor” in the present disclosure. The transistors AMPA and SELA correspond to a specific example of a “first output circuit” in the present disclosure. The transistors AMPB and SELB correspond to a specific example of a “second output circuit” in the present disclosure.

The AD converter 32A corresponds to a specific example of a “first conversion circuit” in the present disclosure. The AD converter 32B corresponds to a specific example of a “second conversion circuit” in the present disclosure. The switch SW1 corresponds to a specific example of a “first switch” in the present disclosure. The switch SW2 corresponds to a specific example of a “second switch” in the present disclosure. The switch SW3 corresponds to a specific example of a “third switch” in the present disclosure. The switch SW4 corresponds to a specific example of a “fourth switch” in the present disclosure. The photodetection control section 25 corresponds to a specific example of a “second control circuit” in the present disclosure.

### [Operation and Workings]

Next, operation and workings of the photodetection system 1 according to the present embodiment are described herein.

### (Outline of Overall Operation)

An outline of overall operation of the photodetection system 1 is first described herein with reference to FIGS. 1 and 2. The light-emitting section 11 performs light-emitting operation where light emission and non-light emission are alternately repeated on the basis of an instruction from the control section 14 to emit the light pulse L0. The photodetection unit 20 receives the reflected light pulse L1 corresponding to the light pulse L0 that the light-emitting section 11 has emitted on the basis of an instruction from the control section 14 to generate a distance image. Specifically, each of the plurality of light-receiving pixels P in the pixel array 21 in the photodetection unit 20 receives the reflected light pulse L1 to generate the pixel signals SIGA and SIGB. The readout section 30 performs AD conversion on the basis of the pixel signals SIGA and SIGB supplied from the pixel array 21 to generate the data DT1. The processing section 24 generates a distance image in which each pixel value indicates a value about a distance on the basis of the data DT1, and outputs image data of the distance image as the data DT.

### (Detailed Operation)

The photodetection system 1 first performs exposure operation to cause the floating diffusions FDA, FDA2, FDB, and FDB2 in each of the pluralities of light-receiving pixels P1 and P2 to accumulate electric charge. The photodetection system 1 then performs read operation to perform AD conversion on the basis of the pixel signals SIGA and SIGB supplied via the signal lines VSLA and VSLB from the pluralities of light-receiving pixels P1 and P2 to generate the data DT1. The photodetection system 1 then generates a distance image on the basis of the data DT1. This operation is described hereinafter in detail.

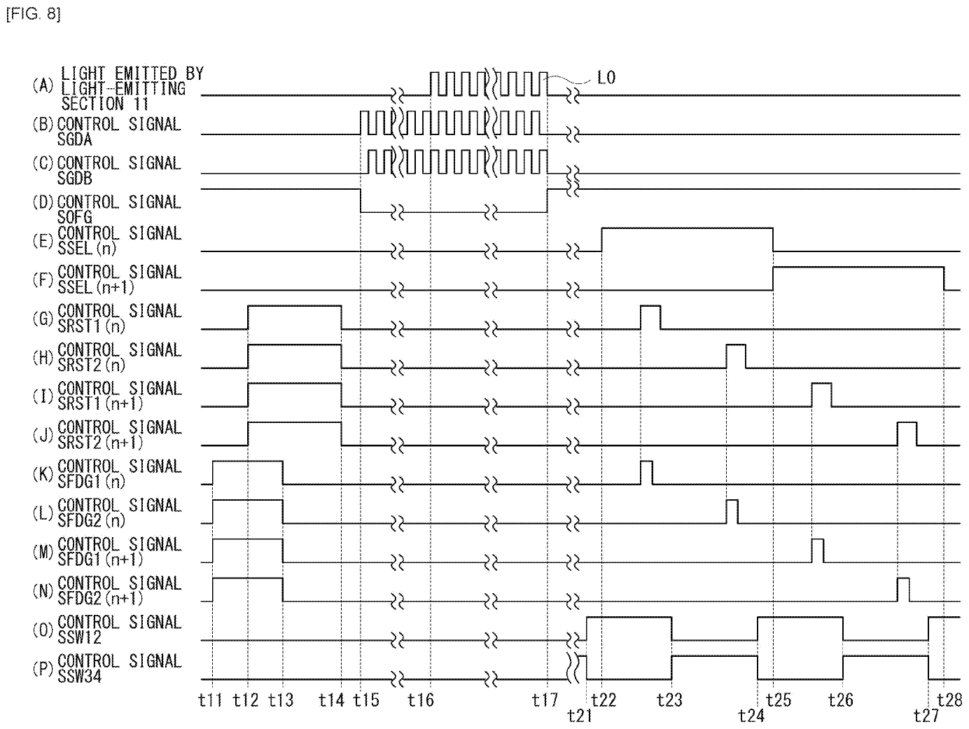

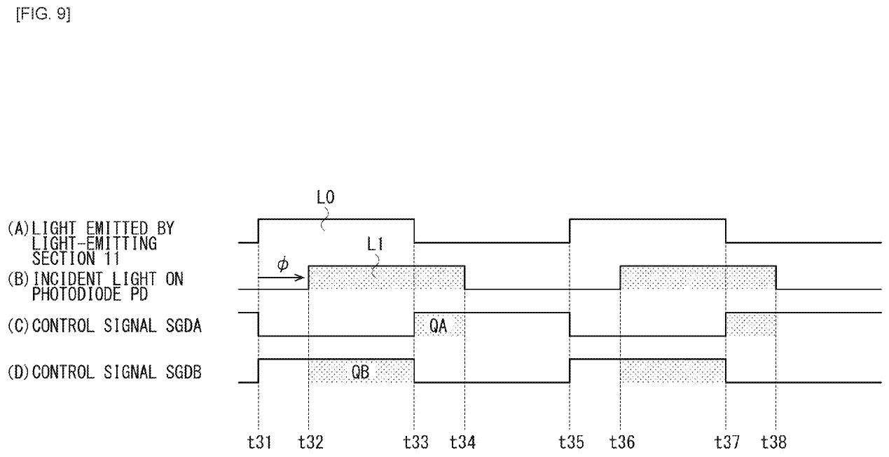

FIG. 7 illustrates an example of exposure operation D1 and read operation D2 in the photodetection system 1. In FIG. 7, an upper end indicates an uppermost part of the pixel array 21, and a lower end indicates a lowermost part of the pixel array 21.

The photodetection system 1 performs the exposure operation D1 in a period ranging from a timing t1 to a timing t2. Specifically, the light-emitting section 11 performs light-emitting operation where light emission and non-light emission are alternately repeated to emit the light pulse L0. Furthermore, the drive section 22 supplies the control signals SGDA and SGDB to the pluralities of light-receiving pixels P1 and P2 in the pixel array 21. The pluralities of light-receiving pixels P1 and P2 detect the reflected light pulse L1 corresponding to the light pulse L0.

The photodetection system 1 then performs the read operation D2 in a period ranging from the timing t2 to a timing t3. Specifically, the drive section 22 sequentially drives the pluralities of light-receiving pixels P1 and P2 in the pixel array 21 per pixel line. Each of the pluralities of light-receiving pixels P1 and P2 supplies the pixel signals SIGA and SIGB via the signal lines VSLA and VSLB to the readout section 30. The readout section 30 then performs AD conversion on the basis of the pixel signals SIGA and SIGB to generate the data DT1.

The photodetection system 1 repeats the exposure operation D1 and the read operation D2 described above. The processing section 24 generates a distance image in which each pixel value indicates a value about a distance on the basis of the data DT1.

Next, operation of the photodetection system 1 in a case where a conversion gain is high in the light-receiving pixel P is described in detail.

FIG. 8 illustrates an operation example of the photodetection system 1, where, (A) indicates a waveform of light emitted by the light-emitting section 11, (B) indicates a waveform of the control signal SGDA, (C) indicates a waveform of the control signal SGDB, (D) indicates a waveform of the control signal SOFG, (E) indicates a waveform of the control signal SSEL pertaining to an n-th pixel line (the control signal SSEL(n)), (F) indicates a waveform of the control signal SSEL pertaining to an (n+1)-th pixel line (the control signal SSEL(n+1)), (G) indicates a waveform of the control signal SRST1 pertaining to the n-th pixel line (a control signal SRST1(n)), (H) indicates a waveform of the control signal SRST2 pertaining to the n-th pixel line (a control signal SRST2(n)), (I) indicates a waveform of the control signal SRST1 pertaining to the (n+1)-th pixel line (a control signal SRST1(n+1)), (J) indicates a waveform of the control signal SRST2 pertaining to the (n+1)-th pixel line (a control signal SRST2(n+1)), (K) indicates a waveform of a control signal SFDG1 pertaining to the n-th pixel line (a control signal SFDG1(n)), (L) indicates a waveform of the control signal SFDG2 pertaining to the n-th pixel line (a control signal SFDG2(n)), (M) indicates a waveform of the control signal SFDG1 pertaining to the (n+1)-th pixel line (a control signal SFDG1(n+1)), (N) indicates a waveform of the control signal SFDG2 pertaining to the (n+1)-th pixel line (a control signal SFDG2(n+1)), (O) indicates a waveform of a control signal SSW12 supplied to the switches SW1 and SW2 in the switch section 29, and (P) indicates a waveform of a control signal SSW34 supplied to the switches SW3 and SW4 in the switch section 29. In a case where the control signal SSW12 is at a low level, the switches SW1 and SW2 each come into the off state. In a case where the control signal SSW12 is at a high level, the switches SW1 and SW2 each come into the on state. Similarly, in a case where the control signal SSW34 is at the low level, the switches SW3 and SW4 each come into the off state. In a case where the control signal SSW34 is at the high level, the switches SW3 and SW4 each come into the on state.

Before a timing t11, the drive section 22 sets the control signal SOFG pertaining to all the pixel lines at the high level ((D) in FIG. 8). Thereby, in the light-receiving pixels P1 and P2 pertaining to all the pixel lines, the transistors OFG each come into the on state, and the voltage VOFG is supplied to the cathodes of the photodiodes PD. As a result, the photodiodes PD are reset.

At the timing t11, the drive section 22 causes the control signals SFDG1 and SFDG2 pertaining to all the pixel lines to change from the low level to the high level ((K) to (N) in FIG. 8). Thereby, in the light-receiving pixels P1 and P2 pertaining to all the pixel lines, the transistors FDGA and FDGB each come into the on state.

Next, at a timing t12, the drive section 22 causes the control signals SRST1 and SRST2 pertaining to all the pixel lines to change from the low level to the high level ((G) to (J) in FIG. 8). Thereby, in the light-receiving pixels P1 and P2 pertaining to all the pixel lines, the transistors RSTA and RSTB each come into the on state. As a result, the voltage VRST is supplied to the floating diffusions FDA, FDA2, FDB, and FDB2. The floating diffusions FDA, FDA2, FDB, and FDB2 are thus reset.

Next, at a timing t13, the drive section 22 causes the control signals SFDG1 and SFDG2 pertaining to all the pixel lines to change from the high level to the low level ((K) to (N) in FIG. 8). Thereby, in the light-receiving pixels P1 and P2 pertaining to all the pixel lines, the transistors FDGA and FDGB each come into the off state.

Next, at a timing t14, the drive section 22 causes the control signals SRST1 and SRST2 pertaining to all the pixel lines to change from the high level to the low level ((G) to (J) in FIG. 8). Thereby, in the light-receiving pixels P1 and P2 pertaining to all the pixel lines, the transistors RSTA and RSTB each come into the off state.

Next, at a timing t15, the drive section 22 causes the control signal SOFG pertaining to all the pixel lines to change from the high level to the low level ((D) in FIG. 8). Thereby, in the light-receiving pixels P1 and P2 pertaining to all the pixel lines, the transistors OFG each come into the off state.

Next, in a period ranging from the timing t15 to a timing t17, the drive section 22 alternately sets the control signal SGDA and the control signal SGDB at the high level ((B) and (C) in FIG. 8). Thereby, in the light-receiving pixels P1 and P2, the transistors GDA and the transistor GDB each alternately come into the on state.

During a period ranging from the timing t16 to the timing t17, the light-emitting section 11 performs light-emitting operation where light emission and non-light emission are alternately repeated to emit the light pulse L0 ((A) in FIG. 8). The light-emitting operation performed by the light-emitting section 11 synchronizes with the control signals SGDA and SGDB. In this example, in a period where the control signal SGDA is at the low level and the control signal SGDB is at the high level, the light-emitting section 11 emits light. In this way, the light-emitting section 11 emits the light pulse L0. The reflected light pulse L1 reflected by a detection target then enters the photodetection unit 20. In the light-receiving pixels P1 and P2, the photodiodes PD generate electric charge on the basis of the reflected light pulse L1. The transistors GDA and the transistor GDB each alternately come into the on state. That is, either the transistor GDA or GDB comes into the on state. Thereby, electric charge generated by the photodiodes PD is selectively accumulated in the floating diffusion FDA or the floating diffusion FDB.

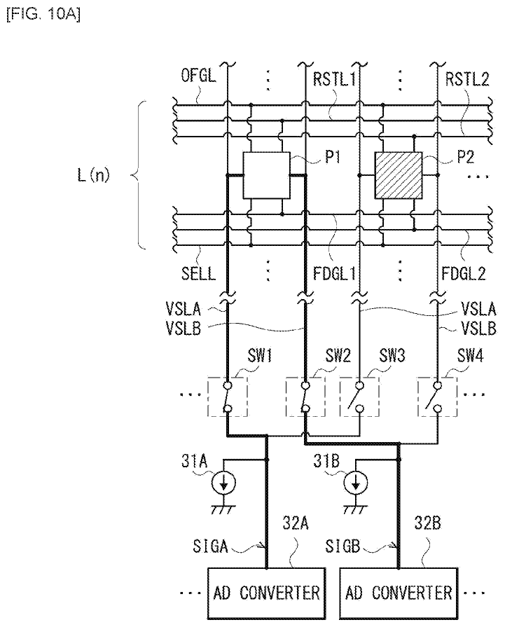

FIG. 9 illustrates an operation example of the light-receiving pixel P, where, (A) indicates a waveform of light emitted by the light-emitting section 11, (B) indicates a waveform of incident light on the photodiode PD, (C) indicates a waveform of the control signal SGDA, and (D) indicates a waveform of the control signal SGDB. In this example, at a timing t31, the light pulse L0 rises, the control signal SGDA falls, and the control signal SGDB rises. Then, at a timing t33 at which there is a phase delay by “π” from the timing t31, the light pulse L0 falls, the control signal SGDA rises, and the control signal SGDB falls. Similarly, at a timing t35 at which there is a phase delay by “π” from the timing t33, the light pulse L0 rises, the control signal SGDA falls, and the control signal SGDB rises. Then, at a timing t37 at which there is a phase delay by “x” from the timing t35, the light pulse L0 falls, the control signal SGDA rises, and the control signal SGDB falls.

A phase of the reflected light pulse L1 delays by a phase φ from a phase of the light pulse L0 ((B) in FIG. 9). The phase φ corresponds to a distance from the photodetection system 1 to the detection target. In this example, at a timing t32 that is delayed by a time corresponding to the phase φ from the timing t31, the reflected light pulse L1 rises, and, at a timing t34 that is delayed by a time corresponding to the phase φ from the timing t33, the reflected light pulse L1 falls. The photodiode PD generates electric charge in a period ranging from the timing t32 to the timings t34 on the basis of the reflected light pulse L1.

The transistor GDA transfers the electric charge generated by the photodiode PD to the floating diffusion FDA in a period where the control signal SGDA is at the high level. The transistor GDB transfers the electric charge generated by the photodiode PD to the floating diffusion FDB in a period where the control signal SGDB is at the high level. That is, the transistor GDA transfers the electric charge generated by the photodiode PD to the floating diffusion FDA in a period ranging from the timing t33 to the timing t34. The transistor GDB transfers the electric charge generated by the photodiode PD to the floating diffusion FDB in a period ranging from the timing t32 to the timing t33. Thereby, in the period ranging from the timing t32 to the timing t33, electric charge QB is accumulated in the floating diffusion FDB. In the period ranging from the timing t33 to the timing t34, electric charge QA is accumulated in the floating diffusion FDA. The electric charge QA and the electric charge QB may change in accordance with the phase q.

As illustrated in FIG. 8, the photodetection system 1 repeats the operation performed in the period ranging from the timing t31 to the timing t35 illustrated in FIG. 9. Thereby, the electric charge QA is repeatedly accumulated in the floating diffusion FDA. The electric charge QB is repeatedly accumulated in the floating diffusion FDB. Thereby, in the floating diffusion FDA, a voltage corresponding to the electric charge QA repeatedly accumulated is generated. Similarly, in the floating diffusion FDB, a voltage corresponding to the electric charge QB repeatedly accumulated is generated. The operation performed in the period ranging from the timing t16 to the timing t17 illustrated in FIG. 8 corresponds to the exposure operation D1 (FIG. 7).

Then, at the timing t17, the light-emitting section 11 ends the light-emitting operation ((A) in FIG. 8). The drive section 22 sets the control signal SGDA and the control signal SGDB each at the low level ((B) and (C) in FIG. 8).

Furthermore, at the timing t17, the drive section 22 sets the control signal SOFG pertaining to all the pixel lines at the high level ((D) in FIG. 8). Thereby, in the light-receiving pixels P1 and P2, the transistors OFG each come into the on state. The voltage VOFG is thus supplied to the cathodes of the photodiodes PD. As a result, the photodiodes PD are reset.

At the timing t17 and later timings, the photodetection system 1 performs the read operation D2 (FIG. 7). The photodetection system 1 performs scanning per one pixel line to perform the read operation D2. The read operation D2 pertaining to the n-th pixel line and the (n+1)-th pixel line is described hereinafter.

At a timing t21, the photodetection control section 25 causes the control signal SSW12 to change from the low level to the high level, and causes the control signal SSW34 to change from the high level to the low level ((O) and (P) in FIG. 8). Thereby, in the switch section 29, the switches SW1 and SW2 each come into the on state, and the switches SW3 and SW4 each come into the off state.

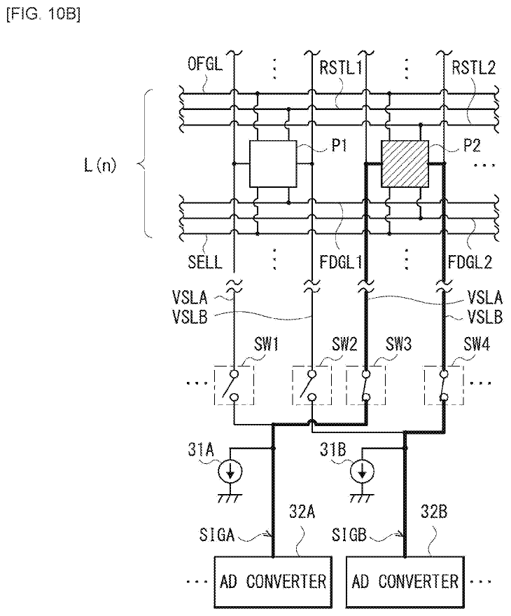

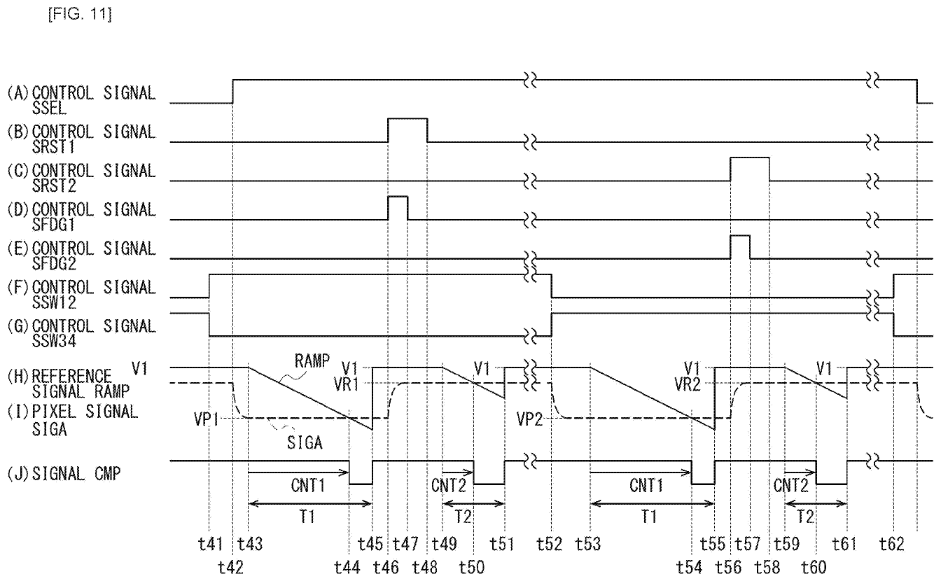

FIG. 10A illustrates operation of the switch section 29. As the switches SW1 and SW2 each come into the on state, and the switches SW3 and SW4 each come into the off state, as described above, the signal line VSLA coupled to the light-receiving pixel P1 pertaining to an n-th pixel line L(n) is coupled to the AD converter 32A, and the signal line VSLB coupled to the light-receiving pixel P1 is coupled to the AD converter 32B.

Then, at a timing t22, the drive section 22 causes the control signal SSEL(n) to change from the low level to the high level ((E) in FIG. 8). Thereby, in the light-receiving pixels P1 and P2 pertaining to the n-th pixel line, the transistors SELA and SELB each come into the on state.

Thereby, the source of the transistor AMPA in the light-receiving pixel P1 pertaining to the n-th pixel line is coupled to the constant current source 31A via the transistor SELA, the signal line VSLA, and the switch SW1. The transistor AMPA thus operates as a source follower. Similarly, the source of the transistor AMPB in the light-receiving pixel P1 is coupled to the constant current source 31B via the transistor SELB, the signal line VSLB, and the switch SW2. The transistor AMPB thus operates as a source follower. Therefore, the light-receiving pixel P1 pertaining to the n-th pixel line supplies a voltage corresponding to a voltage in the floating diffusion FDA to the AD converter 32A as the pixel signal SIGA, and supplies a voltage corresponding to a voltage in the floating diffusion FDB to the AD converter 32B as the pixel signal SIGB.

Then, the AD converter 32A performs AD conversion on the basis of the pixel signal SIGA generated by the light-receiving pixel P1. The AD converter 32B performs AD conversion on the basis of the pixel signal SIGB generated by the light-receiving pixel P1. The AD conversion is described later in detail.

Next, at a timing t23, the photodetection control section 25 causes the control signal SSW12 to change from the high level to the low level, and causes the control signal SSW34 to change from the low level to the high level ((O) and (P) in FIG. 8). Thereby, in the switch section 29, the switches SW1 and SW2 each come into the off state, and the switches SW3 and SW4 each come into the on state.

FIG. 10B illustrates operation of the switch section 29. As the switches SW1 and SW2 each come into the off state, and the switches SW3 and SW4 each come into the on state, as described above, the signal line VSLA coupled to the light-receiving pixel P2 pertaining to the n-th pixel line L(n) is coupled to the AD converter 32A, and the signal line VSLB coupled to the light-receiving pixel P2 is coupled to the AD converter 32B.

Thereby, the source of the transistor AMPA in the light-receiving pixel P2 pertaining to the n-th pixel line is coupled to the constant current source 31A via the transistor SELA, the signal line VSLA, and the switch SW3. The transistor AMPA thus operates as a source follower. Similarly, the source of the transistor AMPB in the light-receiving pixel P2 is coupled to the constant current source 31B via the transistor SELB, the signal line VSLB, and the switch SW4. The transistor AMPB thus operates as a source follower. Therefore, the light-receiving pixel P2 pertaining to the n-th pixel line supplies a voltage corresponding to a voltage in the floating diffusion FDA to the AD converter 32A as the pixel signal SIGA, and supplies a voltage corresponding to a voltage in the floating diffusion FDB to the AD converter 32B as the pixel signal SIGB.

Then, the AD converter 32A performs AD conversion on the basis of the pixel signal SIGA generated by the light-receiving pixel P2. The AD converter 32B performs AD conversion on the basis of the pixel signal SIGB generated by the light-receiving pixel P2.

Next, at a timing t24, the photodetection control section 25 causes the control signal SSW12 to change from the low level to the high level, and causes the control signal SSW34 to change from the high level to the low level ((O) and (P) in FIG. 8). Thereby, in the switch section 29, the switches SW1 and SW2 each come into the on state, and the switches SW3 and SW4 each come into the off state. As a result, as illustrated in FIG. 10A, the signal lines VSLA and VSLB coupled to the light-receiving pixel P1 are respectively coupled to the AD converters 32A and 32B.

Then, at a timing t25, the drive section 22 causes the control signal SSEL(n) to change from the high level to the low level ((E) in FIG. 8), and causes the control signal SSEL(n+1) to change from the low level to the high level ((F) in FIG. 8). Thereby, in the light-receiving pixels P1 and P2 pertaining to the n-th pixel line, the transistors SELA and SELB each come into the off state, and, in the light-receiving pixels P1 and P2 pertaining to the (n+1)-th pixel line, the transistors SELA and SELB each come into the on state. As a result, the light-receiving pixel P1 pertaining to the (n+1)-th pixel line supplies the pixel signal SIGA to the AD converter 32A, and supplies the pixel signal SIGB to the AD converter 32B.

Then, the AD converter 32A performs AD conversion on the basis of the pixel signal SIGA generated by the light-receiving pixel P1. The AD converter 32B performs AD conversion on the basis of the pixel signal SIGB generated by the light-receiving pixel P1.

Next, at a timing t26, the photodetection control section 25 causes the control signal SSW12 to change from the high level to the low level, and causes the control signal SSW34 to change from the low level to the high level ((O) and (P) in FIG. 8). Thereby, in the switch section 29, the switches SW1 and SW2 each come into the off state, and the switches SW3 and SW4 each come into the on state. As a result, as illustrated in FIG. 10B, the signal lines VSLA and VSLB coupled to the light-receiving pixel P2 are respectively coupled to the AD converters 32A and 32B. Then, the light-receiving pixel P2 pertaining to the (n+1)-th pixel line supplies the pixel signal SIGA to the AD converter 32A, and supplies the pixel signal SIGB to the AD converter 32B.

Then, the AD converter 32A performs AD conversion on the basis of the pixel signal SIGA generated by the light-receiving pixel P2. The AD converter 32B performs AD conversion on the basis of the pixel signal SIGB generated by the light-receiving pixel P2.

By focusing on the light-receiving pixels P1 and P2 pertaining to the n-th pixel line, operation of the AD converter 32A performing AD conversion on the basis of the pixel signals SIGA that the light-receiving pixels P1 and P2 generate is described hereinafter in detail.

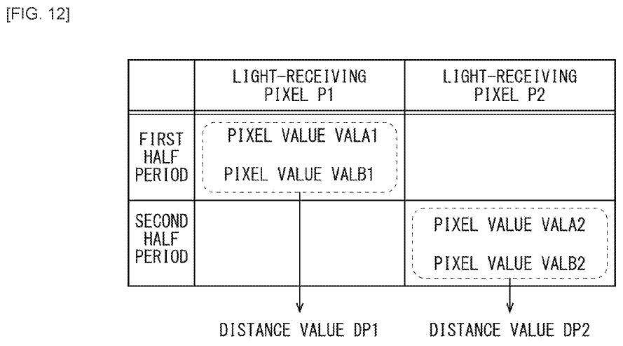

FIG. 11 illustrates an example of AD conversion performed in the AD converter 32A, where (A) indicates a waveform of the control signal SSEL, (B) indicates a waveform of the control signal SRST1, (C) indicates a waveform of the control signal SRST2, (D) indicates a waveform of the control signal SFDG1, (E) indicates a waveform of the control signal SFDG2, (F) indicates a waveform of the control signal SSW12, (G) indicates a waveform of the control signal SSW34, (H) indicates a waveform of the reference signal RAMP, (I) indicates a waveform of the pixel signal SIGA, and (J) indicates a waveform of a signal CMP.

At a timing t41, the photodetection control section 25 first causes the control signal SSW12 to change from the low level to the high level, and causes the control signal SSW34 to change from the high level to the low level ((F) and (G) in FIG. 11). Thereby, in the switch section 29, the switches SW1 and SW2 each come into the on state, and the switches SW3 and SW4 each come into the off state, as illustrated in FIG. 10A. As a result, the signal lines VSLA and VSLB coupled to the light-receiving pixel P1 are respectively coupled to the AD converters 32A and 32B.

Next, at a timing t42, the drive section 22 causes the control signal SSEL to change from the low level to the high level ((A) in FIG. 11). Thereby, in the light-receiving pixels P1 and P2, the transistors SELA and SELB each come into the on state. As a result, the pixel signal SIGA generated by the light-receiving pixel P1 is supplied to the AD converter 32A, and the pixel signal SIGB generated by the light-receiving pixel P1 is supplied to the AD converter 32B.

The pixel signal SIGA generated by the light-receiving pixel P1 is supplied to the AD converter 32A in this way, and thus the voltage of the pixel signal SIGA changes to a voltage VP1 at the timing t42 ((I) in FIG. 11). The voltage VP1 is, in the light-receiving pixel P1, a voltage corresponding to a voltage in the floating diffusion FDA in which electric charge is accumulated.

Next, in a period ranging from a timing t43 to a timing t45 (a conversion period T1), the AD converter 32A performs AD conversion on the basis of the pixel signal SIGA. Specifically, at the timing t43, the reference signal generator 26 starts to cause the voltage of the reference signal RAMP to lower from the voltage V1 at a predetermined degree of change ((H) in FIG. 11). Furthermore, the photodetection control section 25 starts to generate the clock signal CLK. The counter 36 in the AD converter 32A starts count operation of counting pulses of the clock signal CLK.

Then, at the timing t44, the voltage of the reference signal RAMP falls below the voltage of the pixel signal SIGA ((H) and (I) in FIG. 11). Accordingly, the comparator 35 in the AD converter 32A causes the signal CMP to change from the high level to the low level ((J) in FIG. 11). Thereby, the counter 36 stops the count operation. The count value CNT1 of the counter 36 at this time is, in the light-receiving pixel P1, a value corresponding to the voltage in the floating diffusion FDA in which electric charge is accumulated.

Next, at the timing t45, as the conversion period T1 ends, the reference signal generator 26 stops changing of the voltage of the reference signal RAMP, and sets the voltage of the reference signal RAMP to the voltage V1 ((H) in FIG. 11). Accordingly, the voltage of the reference signal RAMP exceeds the voltage of the pixel signal SIGA ((H) and (I) in FIG. 11), and thus the comparator 35 in the AD converter 32A causes the signal CMP to change from the low level to the high level ((J) in FIG. 11). Furthermore, the photodetection control section 25 stops generating of the clock signal CLK.

Next, at a timing t46, the drive section 22 causes the control signal SRST1 to change from the low level to the high level ((B) in FIG. 11), and causes the control signal SFDG1 to change from the low level to the high level ((D) in FIG. 11). Thereby, in the light-receiving pixel P1, the transistors RSTA and RSTB each come into the on state, and the transistors FDGA and FDGB each come into the on state. As a result, the voltage VRST is supplied to the floating diffusions FDA, FDA2, FDB, and FDB2. Thereby, the voltage of the pixel signal SIGA changes to the voltage VR1 ((I) in FIG. 11). The voltage VR1 is, in the light-receiving pixel P1, a voltage corresponding to the voltage VRST in the floating diffusion FDA that has been reset.

Next, at a timing t47, the drive section 22 causes the control signal SFDG1 to change from the high level to the low level ((D) in FIG. 11). Thereby, in the light-receiving pixel P1, the transistors FDGA and FDGB each come into the off state.

Next, at a timing t48, the drive section 22 causes the control signal SRST1 to change from the high level to the low level ((B) in FIG. 11). Thereby, in the light-receiving pixel P1, the transistors RSTA and RSTB each come into the off state.

Next, in a period ranging from a timing t49 to a timing t51 (a conversion period T2), the AD converter 32A performs AD conversion on the basis of the pixel signal SIGA. Specifically, at the timing t49, the reference signal generator 26 starts to cause the voltage of the reference signal RAMP to lower from the voltage V1 at a predetermined degree of change ((H) in FIG. 11). Furthermore, the photodetection control section 25 starts to generate the clock signal CLK. The counter 36 in the AD converter 32A starts count operation of counting pulses of the clock signal CLK.

Then, at the timing t50, the voltage of the reference signal RAMP falls below the voltage of the pixel signal SIGA ((H) and (I) in FIG. 11). Accordingly, the comparator 35 in the AD converter 32A causes the signal CMP to change from the high level to the low level ((J) in FIG. 11). Thereby, the counter 36 stops the count operation. The count value CNT2 of the counter 36 at this time is, in the light-receiving pixel P1, a value corresponding to the voltage VRST in the floating diffusion FDA that has been reset.

Next, at the timing t51, as the conversion period T2 ends, the reference signal generator 26 stops changing of the voltage of the reference signal RAMP, and causes the voltage of the reference signal RAMP to change to the voltage V1 ((H) in FIG. 11). Accordingly, the voltage of the reference signal RAMP exceeds the voltage of the pixel signal SIGA ((H) and (I) in FIG. 11), and thus the comparator 35 in the AD converter 32A causes the signal CMP to change from the low level to the high level ((J) in FIG. 11). Furthermore, the photodetection control section 25 stops generating of the clock signal CLK.

Then, in a period ranging from the timing t51 to a timing t52, the latch 37 in the AD converter 32A uses the data DT1 to supply a digital code indicating the count value CNT1 and a digital code indicating the count value CNT2 to the processing section 24. The processing section 24 subtracts the count value CNT1 from the count value CNT2, for example, to calculate a pixel value VALA1 pertaining to the pixel signal SIGA in the light-receiving pixel P1.

Although the operation of the AD converter 32A has been described in this example, the AD converter 32B similarly performs AD conversion on the basis of the pixel signal SIGB generated by the light-receiving pixel P1 to generate the count values CNT1 and CNT2. The processing section 24 subtracts the count value CNT1 from the count value CNT2 to calculate a pixel value VALB1 pertaining to the pixel signal SIGB in the light-receiving pixel P1.

Next, at the timing t52, the photodetection control section 25 causes the control signal SSW12 to change from the high level to the low level, and causes the control signal SSW34 to change from the low level to the high level ((F) and (G) in FIG. 11). Thereby, in the switch section 29, the switches SW1 and SW2 each come into the off state, and the switches SW3 and SW4 each come into the on state, as illustrated in FIG. 10B. As a result, the signal lines VSLA and VSLB coupled to the light-receiving pixel P2 are respectively coupled to the AD converters 32A and 32B. In this way, the pixel signal SIGA generated by the light-receiving pixel P2 is supplied to the AD converter 32A, and the pixel signal SIGB generated by the light-receiving pixel P2 is supplied to the AD converter 32B.

The pixel signal SIGA generated by the light-receiving pixel P2 is supplied to the AD converter 32A in this way, and thus the voltage of the pixel signal SIGA changes to a voltage VP2 at the timing t52 ((I) in FIG. 11). The voltage VP2 is, in the light-receiving pixel P2, a voltage corresponding to a voltage in the floating diffusion FDA.

Next, in a period ranging from a timing t53 to a timing t55 (the conversion period T1), the AD converter 32A performs AD conversion on the basis of the pixel signal SIGA. Specifically, at the timing t53, the reference signal generator 26 starts to cause the voltage of the reference signal RAMP to lower from the voltage V1 at a predetermined degree of change ((H) in FIG. 11). Furthermore, the photodetection control section 25 starts to generate the clock signal CLK. The counter 36 in the AD converter 32A starts count operation of counting pulses of the clock signal CLK.

Then, at the timing t54, the voltage of the reference signal RAMP falls below the voltage of the pixel signal SIGA ((H) and (I) in FIG. 11). Accordingly, the comparator 35 in the AD converter 32A causes the signal CMP to change from the high level to the low level ((J) in FIG. 11). Thereby, the counter 36 stops the count operation. The count value CNT1 of the counter 36 at this time is, in the light-receiving pixel P2, a value corresponding to a voltage in the floating diffusion FDA in which electric charge is accumulated.

Next, at the timing t55, as the conversion period T1 ends, the reference signal generator 26 stops changing of the voltage of the reference signal RAMP, and sets the voltage of the reference signal RAMP to the voltage V1 ((H) in FIG. 11). Accordingly, the voltage of the reference signal RAMP exceeds the voltage of the pixel signal SIGA ((H) and (I) in FIG. 11), and thus the comparator 35 in the AD converter 32A causes the signal CMP to change from the low level to the high level ((J) in FIG. 11). Furthermore, the photodetection control section 25 stops generating of the clock signal CLK.

Next, at a timing t56, the drive section 22 causes the control signal SRST2 to change from the low level to the high level ((C) in FIG. 11), and causes the control signal SFDG2 to change from the low level to the high level ((E) in FIG. 11). Thereby, in the light-receiving pixel P2, the transistors RSTA and RSTB each come into the on state, and the transistors FDGA and FDGB each come into the on state. As a result, the voltage VRST is supplied to the floating diffusions FDA, FDA2, FDB, and FDB2. Thereby, the voltage of the pixel signal SIGA changes to the voltage VR2 ((I) in FIG. 11). The voltage VR2 is, in the light-receiving pixel P2, a voltage corresponding to the voltage VRST in the floating diffusion FDA that has been reset.

Next, at a timing t57, the drive section 22 causes the control signal SFDG2 to change from the high level to the low level ((E) in FIG. 11). Thereby, in the light-receiving pixel P2, the transistors FDGA and FDGB each come into the off state.

Next, at a timing t58, the drive section 22 causes the control signal SRST2 to change from the high level to the low level ((C) in FIG. 11). Thereby, in the light-receiving pixel P2, the transistors RSTA and RSTB each come into the off state.

Next, in a period ranging from a timing t59 to a timing t61 (the conversion period T2), the AD converter 32A performs AD conversion on the basis of the pixel signal SIGA. Specifically, at the timing t59, the reference signal generator 26 starts to cause the voltage of the reference signal RAMP to lower from the voltage V1 at a predetermined degree of change ((H) in FIG. 11). Furthermore, the photodetection control section 25 starts to generate the clock signal CLK. The counter 36 in the AD converter 32A starts count operation of counting pulses of the clock signal CLK.

Then, at the timing t60, the voltage of the reference signal RAMP falls below the voltage of the pixel signal SIGA ((H) and (I) in FIG. 11). Accordingly, the comparator 35 in the AD converter 32A causes the signal CMP to change from the high level to the low level ((J) in FIG. 11). Thereby, the counter 36 stops the count operation. The count value CNT2 of the counter 36 at this time is, in the light-receiving pixel P1, a value corresponding to the voltage VRST in the floating diffusion FDA that has been reset.

Next, at the timing t61, as the conversion period T2 ends, the reference signal generator 26 stops changing of the voltage of the reference signal RAMP, and causes the voltage of the reference signal RAMP to change to the voltage V1 ((H) in FIG. 11). Accordingly, the voltage of the reference signal RAMP exceeds the voltage of the pixel signal SIGA ((H) and (I) in FIG. 11), and thus the comparator 35 in the AD converter 32A causes the signal CMP to change from the low level to the high level ((J) in FIG. 11). Furthermore, the photodetection control section 25 stops generating of the clock signal CLK.

Then, in a period ranging from the timing t61 to a timing t62, the latch 37 in the AD converter 32A uses the data DT1 to supply a digital code indicating the count value CNT1 and a digital code indicating the count value CNT2 to the processing section 24. The processing section 24 subtracts the count value CNT1 from the count value CNT2 to calculate a pixel value VALA2 pertaining to the pixel signal SIGA in the light-receiving pixel P2, for example.

Although the operation of the AD converter 32A has been described in this example, the AD converter 32B similarly performs AD conversion on the basis of the pixel signal SIGB generated by the light-receiving pixel P2 to generate the count values CNT1 and CNT2. The processing section 24 subtracts the count value CNT1 from the count value CNT2 to calculate a pixel value VALB2 pertaining to the pixel signal SIGB in the light-receiving pixel P2.

Although the operation of the photodetection system 1 in a case where a conversion gain is high in the light-receiving pixel P has been described, the control signals SFDG1 and SFDG2 pertaining to all the pixel lines are each kept at the high level in a case where a conversion gain in the light-receiving pixel P is to be lowered. In this case, in each of the light-receiving pixels P1 and P2, the floating diffusion FDA and the floating diffusion FDA2 are coupled to each other, and the floating diffusion FDB and the floating diffusion FDB2 are coupled to each other. Another operation is identical to the operation in a case where a conversion gain is high in the light-receiving pixel P.

FIG. 12 illustrates an operation example of the processing section 24. In a first half period in the period illustrated in FIG. 11, the processing section 24 calculates the pixel value VALA1 pertaining to the pixel signal SIGA in the light-receiving pixel P1 and the pixel value VALB1 pertaining to the pixel signal SIGB in the light-receiving pixel P1. Then, in a second half period in the period illustrated in FIG. 11, the processing section 24 calculates the pixel value VALA1 pertaining to the pixel signal SIGA in the light-receiving pixel P2 and the pixel value VALB1 pertaining to the pixel signal SIGB in the light-receiving pixel P2.

The processing section 24 performs noise removal processing on the pixel values VALA1 and VALB1 calculated in the first half period, and calculates, on the basis of the pixel values VALA1 and VALB1 having undergone the noise removal processing, a time of flight of light of the reflected light pulse L1 that the light-receiving pixel P1 has detected, to calculate a distance value DP1 in the light-receiving pixel P1. That is, the pixel value VALA1 is a value corresponding to the voltage in the floating diffusion FDA in which the electric charge QA is repeatedly accumulated in the light-receiving pixel P1, and the pixel value VALB1 is a value corresponding to the voltage in the floating diffusion FDB in which the electric charge QB is repeatedly accumulated in the light-receiving pixel P1. Therefore, the processing section 24 is able to calculate the distance value DP1 in the light-receiving pixel P1 on the basis of the pixel values VALA1 and VALB1 having undergone the noise removal processing.

Similarly, the processing section 24 performs noise removal processing on the pixel values VALA2 and VALB2 calculated in the second half period, and calculates, on the basis of the pixel values VALA2 and VALB2 having undergone the noise removal processing, a time of flight of light of the reflected light pulse L1 that the light-receiving pixel P2 has detected, to calculate a distance value DP2 in the light-receiving pixel P2. That is, the pixel value VALA2 is a value corresponding to the voltage in the floating diffusion FDA in which the electric charge QA is repeatedly accumulated in the light-receiving pixel P2, and the pixel value VALB2 is a value corresponding to the voltage in the floating diffusion FDB in which the electric charge QB is repeatedly accumulated in the light-receiving pixel P2. Therefore, the processing section 24 is able to calculate the distance value DP2 in the light-receiving pixel P2 on the basis of the pixel values VALA2 and VALB2 having undergone the noise removal processing.

Note herein that the pixel value VALA1 corresponds to a specific example of a “first conversion result” in the present disclosure. The pixel value VALB1 corresponds to a specific example of a “second conversion result” in the present disclosure. The pixel value VALA2 corresponds to a specific example of a “third conversion result” in the present disclosure. The pixel value VALB2 corresponds to a specific example of a “fourth conversion result” in the present disclosure.

As described above, the photodetection system 1 is provided with: the light-receiving pixels P1 and P2 arranged side by side in the horizontal direction; the signal lines VSLA and VSLB extending in the vertical direction and being coupled to the light-receiving pixel P1; the signal lines VSLA and VSLB extending in the vertical direction and being coupled to the light-receiving pixel P2; the control line RSTL1 and the control line RSTL2 extending in the horizontal direction and being coupled to the light-receiving pixel P1 and the light-receiving pixel P2, respectively; and the drive section 22 that controls operations of the light-receiving pixels P1 and P2 via the control line RSTL1 and the control line RSTL2. Then, the gates of the transistors RSTA and RSTB in the light-receiving pixel P1 are coupled to the control line RSTL1, and the gates of the transistors RSTA and RSTB in the light-receiving pixel P2 are coupled to the control line RSTL2. Thereby, in the photodetection system 1, as illustrated in FIG. 11, the drive section 22 is able to bring the transistors RSTA and RSTB in the light-receiving pixel P1 each into the on state in a first period, and to bring the transistors RSTA and RSTB in the light-receiving pixel P2 each into the on state in a second period.

Furthermore, in the photodetection system 1, the photodetection control section 25 brings the switches SW1 and SW2 each into the on state in the first operation period, and brings the switches SW3 and SW4 each into the on state in the second operation period, for example. Thereby, as illustrated in FIG. 11, the AD converters 32A and 32B are able to perform AD conversion on the basis of the pixel signals SIGA and SIGB that the light-receiving pixel P1 has generated in the first half period, and to perform AD conversion on the basis of the pixel signals SIGA and SIGB that the light-receiving pixel P2 has generated in the second half period. By performing AD conversion in a time division manner as described above in the photodetection system 1, it is possible to reduce the number of the AD converters 32A and 34B. That is, in a case where such processing as described above is not performed in a time division manner, it is necessary to provide a plurality of AD converters to respectively correspond to a plurality of signal lines. This case results in an increase in the number of the plurality of AD converters. Meanwhile, in the photodetection system 1, in this example, as illustrated in FIG. 3, it is possible to provide the AD converters 32A and 32B respectively for the signal lines VSLA and VSLB coupled to the light-receiving pixel P1 and the signal lines VSLA and VSLB coupled to the light-receiving pixel P2. That is, it is possible to provide two AD converters for four signal lines. Thereby, it is possible to reduce a circuit area in the photodetection system 1.

### [Effects]

As described above, the present embodiment is provided with: the light-receiving pixels P1 and P2 arranged side by side in the horizontal direction; the signal lines VSLA and VSLB extending in the vertical direction and being coupled to the light-receiving pixel P1; the signal lines VSLA and VSLB extending in the vertical direction and being coupled to the light-receiving pixel P2; the control line RSTL1 and the control line RSTL2 extending in the horizontal direction and being coupled to the light-receiving pixel P1 and the light-receiving pixel P2, respectively; and the drive section 22 that controls operations of the light-receiving pixels P1 and P2 via the control line RSTL1 and the control line RSTL2. Then, the gates of the transistors RSTA and RSTB in the light-receiving pixel P1 are coupled to the control line RSTL1, and the gates of the transistors RSTA and RSTB in the light-receiving pixel P2 are coupled to the control line RSTL2. Thereby, it is possible to reduce a circuit area.

### Modification Example 1-1

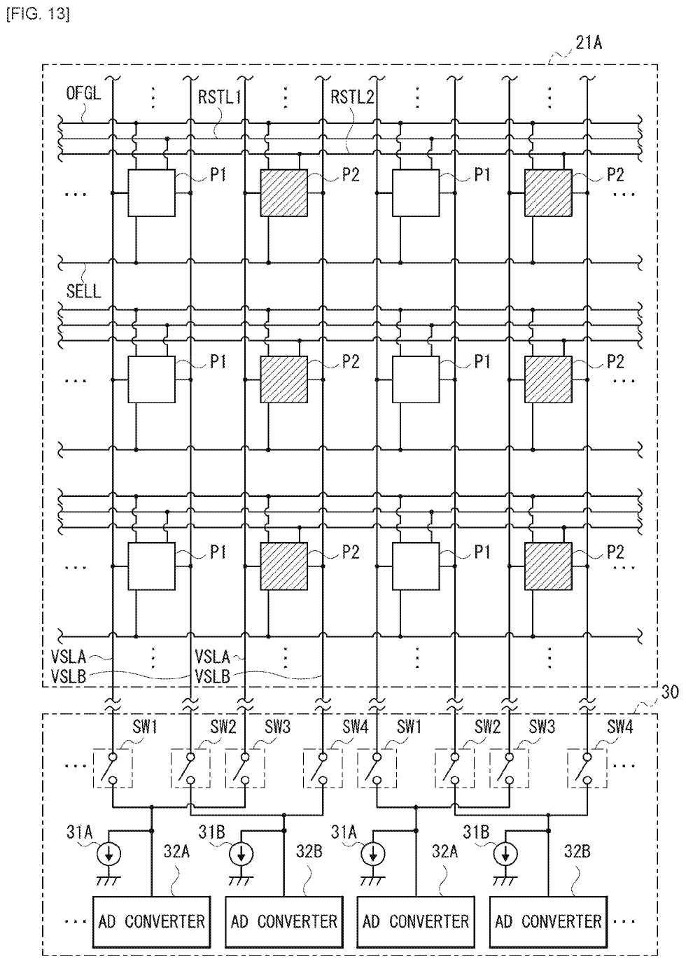

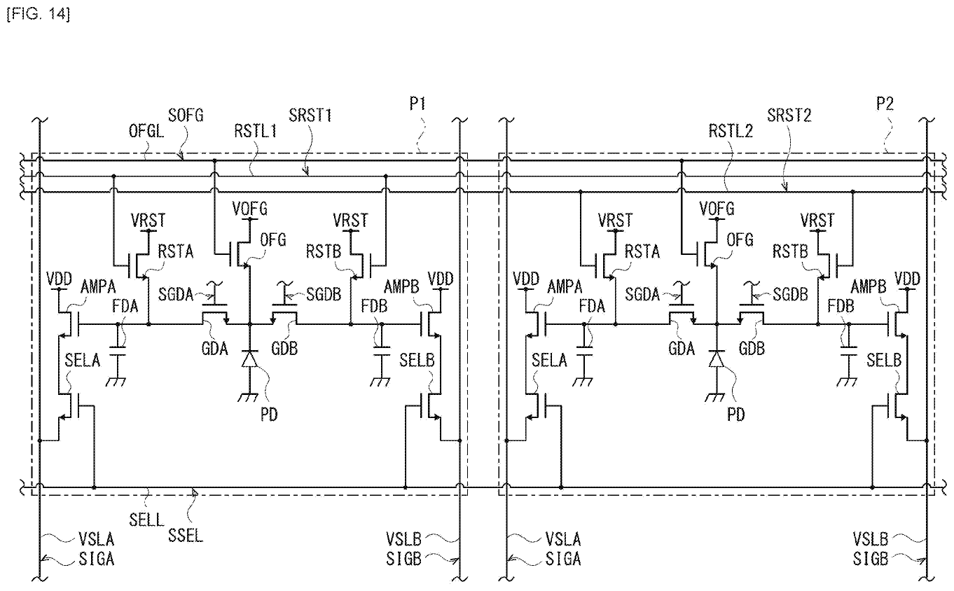

In the embodiment described above, as illustrated in FIG. 4, the transistors FDGA and FDGB and the floating diffusions FDA2 and FDB2 are provided to make it possible to change a conversion gain of converting electric charge into a voltage in the light-receiving pixel P. However, this is not limitative. Alternatively, the transistors FDGA and FDGB and the floating diffusions FDA2 and FDB2 may not be provided, as in a pixel array 21A illustrated in FIGS. 13 and 14. The pixel array 21A includes the plurality of control lines OFGL, the plurality of control lines RSTL1, the plurality of control lines RSTL2, the plurality of control lines SELL, the plurality of signal lines VSLA, and the plurality of signal lines VSLB. The light-receiving pixel P1 is coupled to the control lines OFGL, RSTL1, and SELL and the signal lines VSLA and VSLB. The light-receiving pixel P2 is coupled to the control lines OFGL, RSTL2, and SELL and the signal lines VSLA and VSLB.

### Modification Example 1-2

In the embodiment described above, as illustrated in FIG. 12, the processing section 24 calculates the distance value DP1 in the light-receiving pixel P1 on the basis of the pixel values VALA1 and VALB1 calculated in the first half period, and calculates the distance value DP2 in the light-receiving pixel P2 on the basis of the pixel values VALA2 and VALB2 calculated in the second half period. However, this is not limitative. Alternatively, for example, the processing section 24 may calculate the distance value DP1 further on the basis of the pixel values VALA2 and VALB2 acquired in the second half period, in addition to the pixel values VALA1 and VALB1 acquired in the first half period, and may calculate the distance value DP2 further on the basis of the pixel values VALA1 and VALB1 acquired in the first half period, in addition to the pixel values VALA2 and VALB2 acquired in the second half period. Operation of the processing section 24 according to the present modification example is described hereinafter in detail.

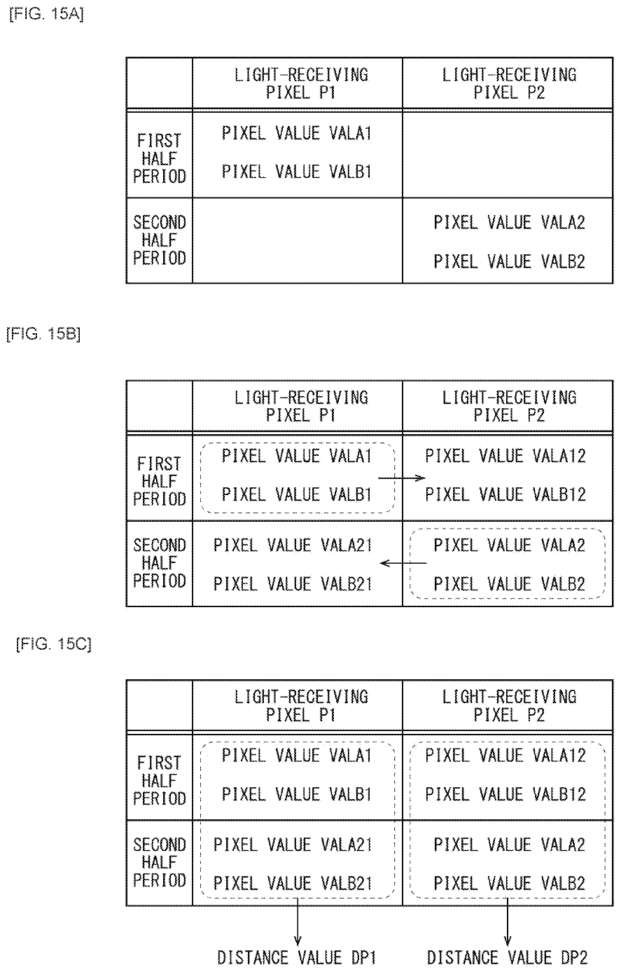

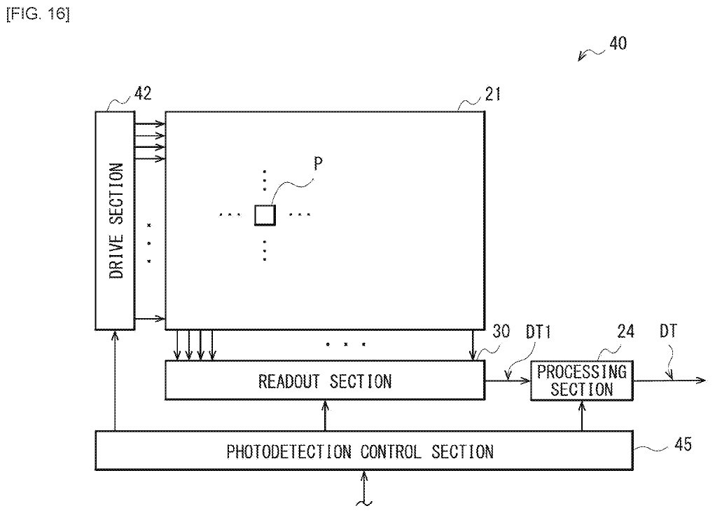

FIGS. 15A to 15C illustrate an operation example of the processing section 24 according to the present modification example. As illustrated in FIG. 15A, the processing section 24 first calculates, in a first half period, the pixel value VALA1 pertaining to the pixel signal SIGA in the light-receiving pixel P1 and the pixel value VALB1 pertaining to the pixel signal SIGB in the light-receiving pixel P1. The processing section 24 then calculates, in a second half period, the pixel value VALA1 pertaining to the pixel signal SIGA in the light-receiving pixel P2 and the pixel value VALB1 pertaining to the pixel signal SIGB in the light-receiving pixel P2.

Next, the processing section 24 generates, as illustrated in FIG. 15B, pixel values VALA12 and VALB12 in the light-receiving pixel P2 on the basis of the pixel values VALA1 and VALB1 calculated in the first half period. For example, the pixel value VALA12 is identical to the pixel value VALA1, and the pixel value VALB12 is identical to the pixel value VALB1. Similarly, the processing section 24 generates pixel values VALA21 and VALB21 in the light-receiving pixel P1 on the basis of the pixel values VALA2 and VALB2 calculated in the second half period. For example, the pixel value VALA21 is identical to the pixel value VALA2, and the pixel value VALB21 is identical to the pixel value VALB2.

Next, as illustrated in FIG. 15C, the processing section 24 synthesizes the pixel values VALA1 and VALB1 and the pixel values VALA21 and VALB21 with each other, performs noise removal processing on the synthesized pixel value, and calculates a time of flight of light of the reflected light pulse L1 on the basis of the pixel value having undergone the noise removal processing, to calculate the distance value DP1 in the light-receiving pixel P1. Similarly, the processing section 24 synthesizes the pixel values VALA2 and VALB2 and the pixel values VALA12 and VALB12 with each other, performs noise removal processing on the synthesized pixel value, and calculates a time of flight of light of the reflected light pulse L1 on the basis of the pixel value having undergone the noise removal processing, to calculate the distance value DP2 in the light-receiving pixel P2.

Thereby, in the present modification example, it is possible to reduce noise in a distance image, as compared with a case of the embodiment described above.

In the present modification example, the processing section 24 generates the distance values DP1 and DP2 with the method illustrated in FIGS. 15A to 15C. However, this is not limitative. For example, the processing section 24 may have two operation modes, i.e., a first operation mode and a second operation mode. In the first operation mode, the processing section 24 may calculate the distance values DP1 and DP2 with the method illustrated in the embodiment described above. In the second operation mode, the processing section 24 may calculate the distance values DP1 and DP2 with the method illustrated in FIGS. 15A to 15C.

### Other Modification Examples

Furthermore, two or more of the modification examples described above may be combined with each other.

### 2. Second Embodiment

Next, a photodetection system according to a second embodiment is described. In the present embodiment, a drive method that differs from the drive method according to the first embodiment described above is used to drive the pixel array 21. It is to be noted that components substantially the same as those of the photodetection system 1 according to the first embodiment described above are denoted by the same reference numerals, and descriptions thereof are omitted as appropriate.

FIG. 16 illustrates a configuration example of a photodetection unit 40 in the photodetection system according to the second embodiment. The photodetection unit 40 includes a drive section 42 and a photodetection control section 45.

The drive section 42 is configured to drive the pluralities of light-receiving pixels P1 and P2 on the basis of an instruction from the photodetection control section 45.

The photodetection control section 45 is configured to supply control signals to the drive section 42, the readout section 30, and the processing section 24 to control operations of respective circuits of the drive section 42, the readout section 30, and the processing section 24 to control operation of the photodetection unit 40.

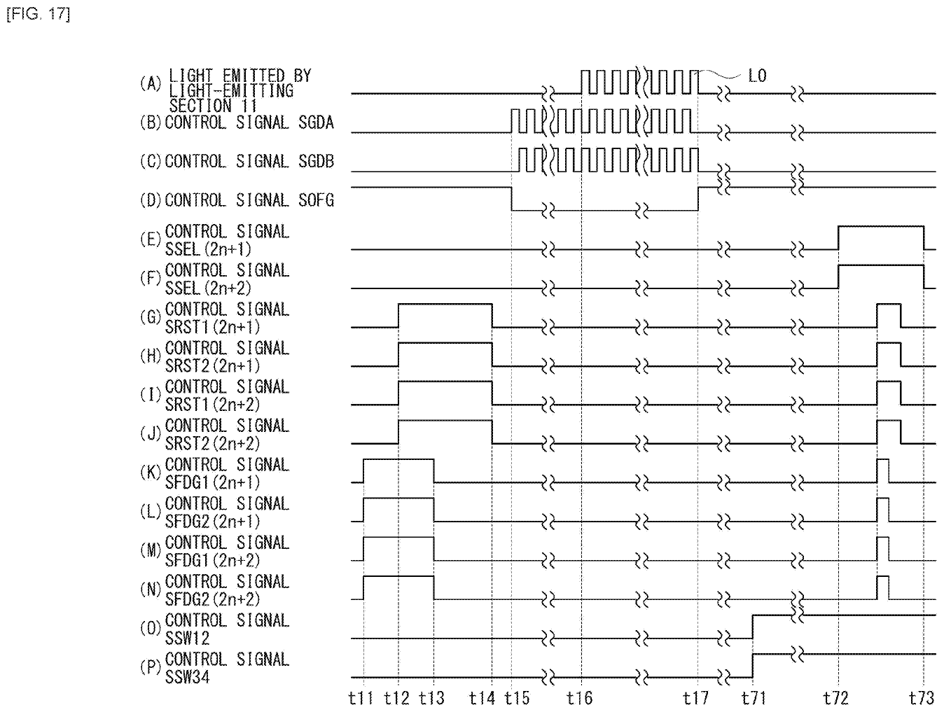

FIG. 17 illustrates an operation example of the photodetection system according to the present embodiment, where, (A) indicates a waveform of light emitted by the light-emitting section 11, (B) indicates a waveform of the control signal SGDA, (C) indicates a waveform of the control signal SGDB, (D) indicates a waveform of the control signal SOFG, (E) indicates a waveform of the control signal SSEL pertaining to a (2n+1)-th pixel line (a control signal SSEL(2n+1)), (F) indicates a waveform of the control signal SSEL pertaining to a (2n+2)-th pixel line (a control signal SSEL(2n+2)), (G) indicates a waveform of the control signal SRST1 pertaining to the (2n+1)-th pixel line (a control signal SRST1(2n+1)), (H) indicates a waveform of the control signal SRST2 pertaining to the (2n+2)-th pixel line (a control signal SRST2(2n+2)), (I) indicates a waveform of the control signal SRST1 pertaining to the (2n+2)-th pixel line (a control signal SRST1(2n+2)), (J) indicates a waveform of the control signal SRST2 pertaining to the (2n+2)-th pixel line (the control signal SRST2(2n+2)), (K) indicates a waveform of the control signal SFDG1 pertaining to the (2n+1)-th pixel line (a control signal SFDG1(2n+1)), (L) indicates a waveform of the control signal SFDG2 pertaining to the (2n+1)-th pixel line (a control signal SFDG2(2n+1)), (M) indicates a waveform of the control signal SFDG1 pertaining to the (2n+2)-th pixel line (a control signal SFDG1(2n+2)), (N) indicates a waveform of the control signal SFDG2 pertaining to the (2n+2)-th pixel line (a control signal SFDG2(2n+2)), (O) indicates a waveform of the control signal SSW12 supplied to the switches SW1 and SW2 in the switch section 29, and (P) indicates a waveform of the control signal SSW34 supplied to the switches SW3 and SW4 in the switch section 29.

Operation performed until the timing t17 is identical to the operation in the photodetection system 1 according to the first embodiment described above (FIG. 8). At the timing t17 and later timings, the photodetection system according to the present embodiment performs read operation D2 (FIG. 7). The photodetection system according to the present embodiment performs scanning per two pixel lines to perform the read operation D2. The read operation D2 pertaining to the (2n+1)-th pixel line and the (2n+2)-th pixel line is described hereinafter.

At a timing t71, the photodetection control section 45 causes the control signal SSW12 to change from the low level to the high level, and causes the control signal SSW34 to change from the low level to the high level ((O) and (P) in FIG. 17). Thereby, in the switch section 29, the switches SW1, SW2, SW3, and SW4 each come into the on state.

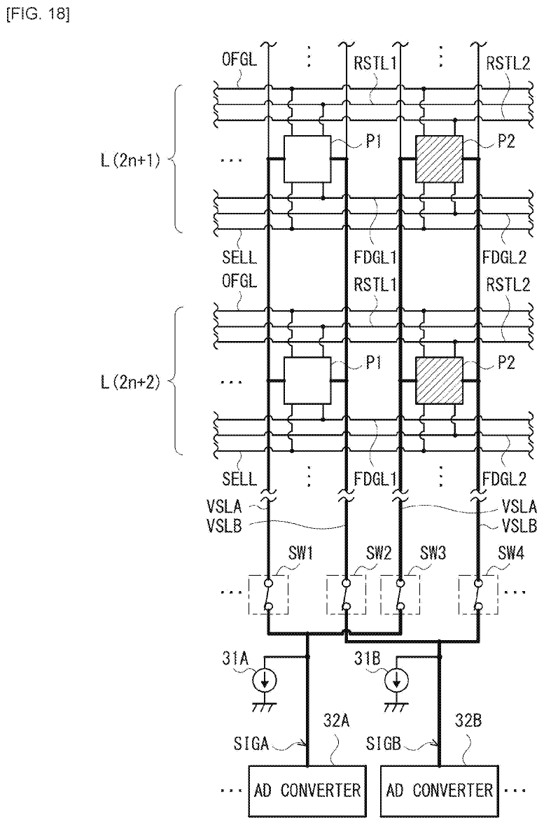

FIG. 18 illustrates operation of the switch section 29. As the switches SW1, SW2, SW3, and SW4 each come into the on state, as described above, the two signal lines VSLA respectively coupled to the light-receiving pixels P1 and P2 pertaining to a (2n+1)-th pixel line L(2n+1) and a (2n+2)-th pixel line L(2n+2) are coupled to the AD converter 32A, and the two signal lines VSLB respectively coupled to the light-receiving pixels P1 and P2 are coupled to the AD converter 32B.

Then, at a timing t72, the drive section 42 causes the control signal SSEL(2n+1) to change from the low level to the high level ((E) in FIG. 17), and causes the control signal SSEL(2n+2) to change from the low level to the high level ((F) in FIG. 17). Thereby, in the light-receiving pixels P1 and P2 pertaining to the (2n+1)-th pixel line and the (2n+2)-th pixel line, the transistors SELA and SELB each come into the on state.

Thereby, the four light-receiving pixels P (the two light-receiving pixels P1 and the two light-receiving pixels P2) illustrated in FIG. 18 are able to each supply a voltage corresponding to a voltage in the floating diffusion FDA to the AD converter 32A as the pixel signal SIGA. In a case where the voltages are substantially identical to each other in the floating diffusions FDA in the four light-receiving pixels P, for example, the four light-receiving pixels P respectively supply the pixel signals SIGA to the AD converter 32A.

Similarly, the four light-receiving pixels P (the two light-receiving pixels P1 and the two light-receiving pixels P2) illustrated in FIG. 18 are able to each supply a voltage corresponding to a voltage in the floating diffusion FDB to the AD converter 32B as the pixel signal SIGB. In a case where the voltages are substantially identical to each other in the floating diffusions FDB in the four light-receiving pixels P, for example, the four light-receiving pixels P respectively supply the pixel signals SIGB to the AD converter 32B.

In this example, the control signals SRST1(2n+1), SRST2(2n+1), SRST1(2n+2), and SRST1(2n+2) are signals identical to each other ((G) to (J) in FIG. 17). Furthermore, the control signals SFDG1(2n+1), SFDG2(2n+1), SFDG1(2n+2), and SFDG2(2n+2) are signals identical to each other ((K) to (N) in FIG. 17). Therefore, the light-receiving pixels P1 and P2 pertaining to the (2n+1)-th pixel line and the (2n+2)-th pixel line are driven at an identical timing.

The AD converter 32A performs AD conversion on the basis of the pixel signal SIGA generated by the light-receiving pixel P1. The AD converter 32B performs AD conversion on the basis of the pixel signal SIGB generated by the light-receiving pixel P1.

Then, at a timing t73, the drive section 42 causes the control signal SSEL(2n+1) to change from the high level to the low level ((E) in FIG. 17), and causes the control signal SSEL(2n+2) to change from the high level to the low level ((F) in FIG. 17). Thereby, in the light-receiving pixels P1 and P2 pertaining to the (2n+1)-th pixel line and the (2n+2)-th pixel line, the transistors SELA and SELB each come into the off state.

In the photodetection system according to the present embodiment, as described above, the drive section 42 brings the transistors RSTA and RSTB in the light-receiving pixel P1 and the transistors RSTA and RSTB in the light-receiving pixel P2 each into the on state in an identical period. Furthermore, the photodetection control section 45 brings the switches SW1 to SW4 each into the on state in an identical operation period. Thereby, in the photodetection system according to the present embodiment, the four light-receiving pixels P are able to supply the pixel signals SIGA to the AD converter 32A, and the four light-receiving pixels P are able to supply the pixel signals SIGB to the AD converter 32B, for example. Thereby, it is possible to shorten a period of time where the pixel signals SIGA and SIGB change, for example. Furthermore, the four transistors AMPA respectively output the pixel signals SIGA and the four transistors AMPB respectively output the pixel signals SIGB, and therefore a gate width of each of the transistors increases in an equivalent manner, thus making it possible to increase an S/N ratio.

In the present embodiment, as described above, the drive section 42 brings the transistors RSTA and RSTB in the light-receiving pixel P1 and the transistors RSTA and RSTB in the light-receiving pixel P2 each into the on state in an identical period. Furthermore, the photodetection control section 45 brings the switches SW1 to SW4 each into the on state in an identical operation period. Thereby, it is possible to shorten a period of time where the pixel signals SIGA and SIGB change, for example. Furthermore, it is possible to increase the S/N ratio, for example.

### Modification Example 2

For example, the photodetection system according to the second embodiment described above may have a first operation mode and a second operation mode to operate as in the first embodiment described above in the first operation mode, and to operate as in the second embodiment described above in the second operation mode.

### 3. Third Embodiment

Next, a photodetection system according to a third embodiment is described. In the present embodiment, the two transistors RSTA and RSTB in the light-receiving pixel P operate at timings that differ from each other. It is to be noted that components substantially the same as those of the photodetection system 1 according to the first embodiment described above are denoted by the same reference numerals, and descriptions thereof are omitted as appropriate.

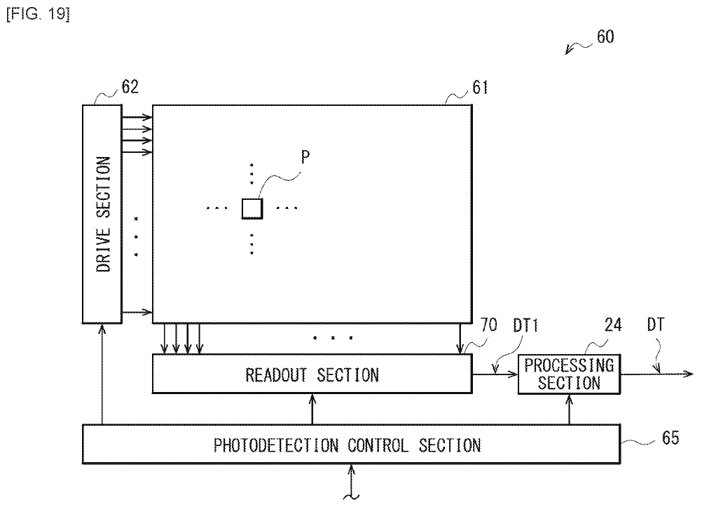

FIG. 19 illustrates a configuration example of a photodetection unit 60 in the photodetection system according to the third embodiment. The photodetection unit 60 includes a pixel array 61, a drive section 62, a readout section 70, and a photodetection control section 65.

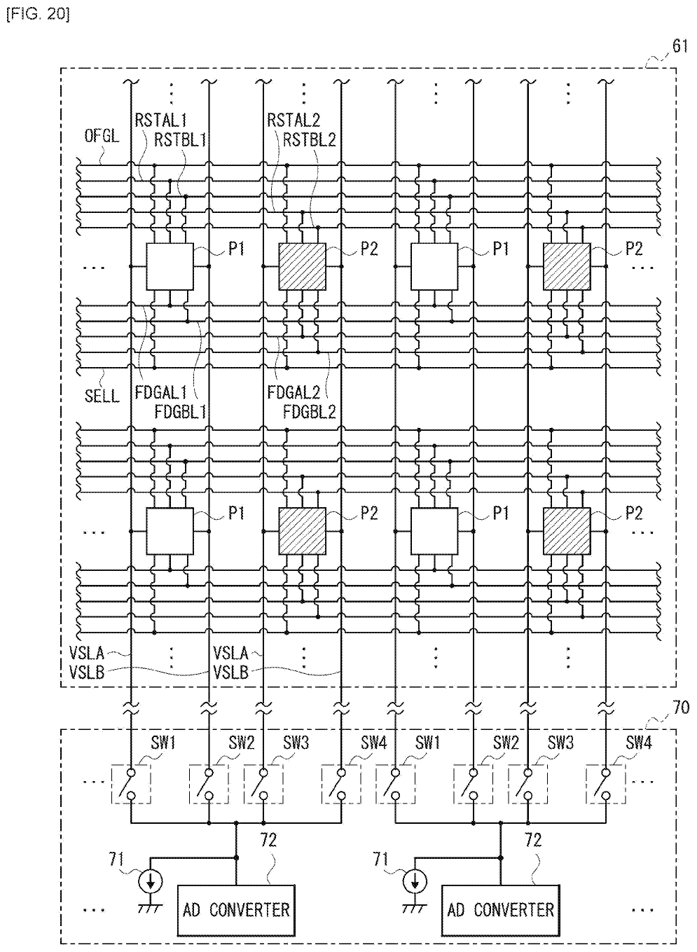

FIG. 20 illustrates a configuration example of the pixel array 61. The pixel array 61 includes the plurality of control lines OFGL, a plurality of control lines RSTAL1, a plurality of control lines RSTBL1, a plurality of control lines RSTAL2, a plurality of control lines RSTBL2, a plurality of control lines FDGAL1, a plurality of control lines FDGBL1, a plurality of control lines FDGAL2, a plurality of control lines FDGBL2, the plurality of control lines SELL, the plurality of signal lines VSLA, and the plurality of signal lines VSLB. The control lines RSTAL1, RSTBL1, RSTAL2, RSTBL2, FDGAL1, FDGBL1, FDGAL2, and FDGBL2 are configured to extend in the horizontal direction (the lateral directions in FIG. 20).

The light-receiving pixel P1 is coupled to the control lines OFGL, RSTAL1, RSTBL1, FDGAL1, FDGBL1, and SELL and the signal lines VSLA and VSLB. The light-receiving pixel P2 is coupled to the control lines OFGL, RSTAL2, RSTBL2, FDGAL2, FDGBL2, and SELL and the signal lines VSLA and VSLB.

FIG. 21 illustrates a configuration example of the light-receiving pixels P.

The gate of the transistor RSTA in the light-receiving pixel P1 is coupled to the control line RSTAL1. The gate of the transistor RSTA in the light-receiving pixel P1 is supplied with the control signal SRSTA1 via the control line RSTAL1 from the drive section 62. The gate of the transistor RSTA in the light-receiving pixel P2 is coupled to the control line RSTAL2. The gate of the transistor RSTA in the light-receiving pixel P2 is supplied with the control signal SRSTA2 via the control line RSTAL2 from the drive section 62.

The gate of the transistor FDGA in the light-receiving pixel P1 is coupled to the control line FDGAL1. The gate of the transistor FDGA in the light-receiving pixel P1 is supplied with a control signal SFDGA1 via the control line FDGAL1 from the drive section 62. The gate of the transistor FDGA in the light-receiving pixel P2 is coupled to the control line FDGAL2. The gate of the transistor FDGA in the light-receiving pixel P2 is supplied with a control signal SFDGA2 via the control line FDGAL2 from the drive section 62.

The gate of the transistor RSTB in the light-receiving pixel P1 is coupled to the control line RSTBL1. The gate of the transistor RSTB in the light-receiving pixel P1 is supplied with a control signal SRSTB1 via the control line RSTBL1 from the drive section 62. The gate of the transistor RSTB in the light-receiving pixel P2 is coupled to the control line RSTBL2. The gate of the transistor RSTB in the light-receiving pixel P2 is supplied with a control signal SRSTB2 via the control line RSTBL2 from the drive section 62.

The gate of the transistor FDGB in the light-receiving pixel P1 is coupled to the control line FDGBL1. The gate of the transistor FDGB in the light-receiving pixel P1 is supplied with a control signal SFDGB1 via the control line FDGBL1 from the drive section 62. The gate of the transistor FDGB in the light-receiving pixel P2 is coupled to the control line FDGBL2. The gate of the transistor FDGB in the light-receiving pixel P2 is supplied with a control signal SFDGB2 via the control line FDGBL2 from the drive section 62.

The drive section 62 (FIG. 19) is configured to drive the pluralities of light-receiving pixels P1 and P2 on the basis of an instruction from the photodetection control section 65. Specifically, the drive section 62 applies the plurality of control signals SOFG respectively to the plurality of control lines OFGL, applies a plurality of control signals SRSTA1 respectively to the plurality of control lines RSTAL1, applies a plurality of control signals SRSTB1 respectively to the plurality of control lines RSTBL1, applies a plurality of control signals SRSTA2 respectively to the plurality of control lines RSTAL2, applies a plurality of control signals SRSTB2 respectively to the plurality of control lines RSTBL2, applies a plurality of control signals SFDGA1 respectively to the plurality of control lines FDGAL1, applies a plurality of control signals SFDGB1 respectively to the plurality of control lines FDGBL1, applies a plurality of control signals SFDGA2 respectively to the plurality of control lines FDGAL2, applies a plurality of control signals SFDGB2 respectively to the plurality of control lines FDGBL2, and applies the plurality of control signals SSEL respectively to the plurality of control lines SELL. Furthermore, the drive section 62 supplies the control signals SGDA and SGDB respectively to the pluralities of light-receiving pixels P1 and P2.

The readout section 70 is configured to perform AD conversion on the basis of the pixel signals SIGA and SIGB supplied via the signal lines VSLA and VSLB from the pixel array 61 to generate the data DT1.

FIG. 22 illustrates a configuration example of the readout section 70. The readout section 70 includes a switch section 69, a plurality of constant current sources 71, a plurality of AD converters 72, and a transfer controller 79.

The switch section 69 includes the plurality of switches SW1, the plurality of switches SW2, the plurality of switches SW3, and the plurality of switches SW4. As illustrated in FIG. 18, one end of the switch SW1 is coupled to the signal line VSLA coupled to the light-receiving pixel P1, and the other end is coupled to the constant current source 71 and the AD converter 72. One end of the switch SW2 is coupled to the signal line VSLB coupled to the light-receiving pixel P1, and the other end is coupled to the constant current source 71 and the AD converter 72. One end of the switch SW3 is coupled to the signal line VSLA coupled to the light-receiving pixel P2, and the other end is coupled to the constant current source 71 and the AD converter 72. One end of the switch SW4 is coupled to the signal line VSLB coupled to the light-receiving pixel P2, and the other end is coupled to the constant current source 71 and the AD converter 72.

One end of the constant current source 71 is coupled to the switches SW1 to SW4 and the AD converter 72, and the other end is grounded.

The AD converter 72 is configured to perform AD conversion on the basis of the pixel signals SIGA and SIGB supplied via the switches SW1 to SW4 to generate a digital code. The AD converter 72 includes the comparator 35, the counter 36, and the latch 37, similarly to the AD converters 32A and 32B according to the first embodiment described above.

The transfer controller 79 is configured to control the latches 37 in the plurality of AD converters 72 to sequentially output digital codes to the bus wiring line BUS on the basis of the control signals CTL supplied from the photodetection control section 65.

The photodetection control section 65 (FIG. 19) is configured to supply control signals to the drive section 62, the readout section 70, and the processing section 24 to control operations of respective circuits of the drive section 62, the readout section 70, and the processing section 24 to control operation of the photodetection unit 60.

Note herein that the control lines RSTAL1 and RSTBL1 each correspond to a specific example of the “first control line” in the present disclosure. The control lines RSTAL2 and RSTBL2 each correspond to a specific example of the “second control line” in the present disclosure. The drive section 62 corresponds to a specific example of the “first control circuit” in the present disclosure. The AD converter 72 corresponds to a specific example of a “conversion circuit” in the present disclosure. The photodetection control section 65 corresponds to a specific example of the “second control circuit” in the present disclosure.

The photodetection system according to the present embodiment performs scanning per one pixel line to perform the read operation D2, similarly to the case of the photodetection system 1 according to the first embodiment described above (FIG. 8).

For example, the photodetection control section 65 brings the switch SW1 into the on state. Thereby, the signal line VSLA coupled to the light-receiving pixel P1 pertaining to the n-th pixel line L(n) is coupled to the AD converter 72. Then, the AD converter 72 performs AD conversion on the basis of the pixel signal SIGA generated by the light-receiving pixel P1.

Next, the photodetection control section 65 brings the switch SW2 into the on state, for example. Thereby, the signal line VSLB coupled to the light-receiving pixel P1 pertaining to the n-th pixel line L(n) is coupled to the AD converter 72. Then, the AD converter 72 performs AD conversion on the basis of the pixel signal SIGB generated by the light-receiving pixel P1.

Next, the photodetection control section 65 brings the switch SW3 into the on state, for example. Thereby, the signal line VSLA coupled to the light-receiving pixel P2 pertaining to the n-th pixel line L(n) is coupled to the AD converter 72. Then, the AD converter 72 performs AD conversion on the basis of the pixel signal SIGA generated by the light-receiving pixel P2.

Next, the photodetection control section 65 brings the switch SW4 into the on state, for example. Thereby, the signal line VSLB coupled to the light-receiving pixel P2 pertaining to the n-th pixel line L(n) is coupled to the AD converter 72. Then, the AD converter 72 performs AD conversion on the basis of the pixel signal SIGB generated by the light-receiving pixel P2.

As described above, the AD converter 72 performs AD conversion, in operation periods that differ from each other, on the basis of the pixel signal SIGA generated by the light-receiving pixel P1, the pixel signal SIGB generated by the light-receiving pixel P1, the pixel signal SIGA generated by the light-receiving pixel P2, and the pixel signal SIGB generated by the light-receiving pixel P2. Therefore, the drive section 62 brings, in periods that differ from each other, the transistor RSTA in the light-receiving pixel P1, the transistor RSTB in the light-receiving pixel P1, the transistor RSTA in the light-receiving pixel P2, and the transistor RSTB in the light-receiving pixel P2 each sequentially into the on state, similarly to the case of the first embodiment described above.

In the photodetection system according to the present embodiment, as described above, the gate of the transistor RSTA in the light-receiving pixel P1 is coupled to the control line RSTLA1, the gate of the transistor RSTB in the light-receiving pixel P1 is coupled to the control line RSTLB1, the gate of the transistor RSTA in the light-receiving pixel P2 is coupled to the control line RSTLA2, and the gate of the transistor RSTB in the light-receiving pixel P2 is coupled to the control line RSTLB2. Thereby, in the photodetection system according to the present embodiment, the drive section 62 is able to bring, in periods that differ from each other, the transistor RSTA in the light-receiving pixel P1, the transistor RSTB in the light-receiving pixel P2, the transistor RSTA in the light-receiving pixel P2, and the transistor RSTB in the light-receiving pixel P2 each sequentially into the on state.

Furthermore, in the photodetection system according to the present embodiment, the photodetection control section 65 brings, in operation periods that differ from each other, the switches SW1, SW2, SW3, and SW4 each sequentially into the on state. Thereby, the AD converter 72 is able to perform AD conversion, in a time division manner, on the basis of the pixel signal SIGA generated by the light-receiving pixel P1, the pixel signal SIGB generated by the light-receiving pixel P1, the pixel signal SIGA generated by the light-receiving pixel P2, and the pixel signal SIGB generated by the light-receiving pixel P2. In the photodetection system according to the present embodiment, by performing AD conversion in a time division manner as described above, it is possible to reduce the number of the AD converters 72, thus making it possible to reduce a circuit area.

In the present embodiment, as described above, the gate of the transistor RSTA in the light-receiving pixel P1 is coupled to the control line RSTLA1, the gate of the transistor RSTB in the light-receiving pixel P1 is coupled to the control line RSTLB1, the gate of the transistor RSTA in the light-receiving pixel P2 is coupled to the control line RSTLA2, and the gate of the transistor RSTB in the light-receiving pixel P2 is coupled to the control line RSTLB2, thus making it possible to reduce a circuit area.

### Modification Example 3

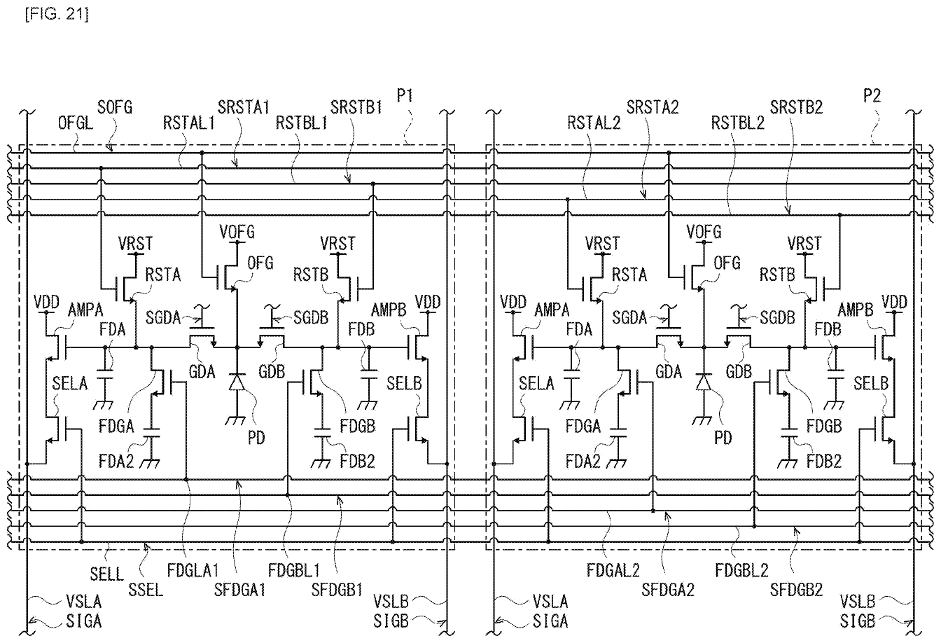

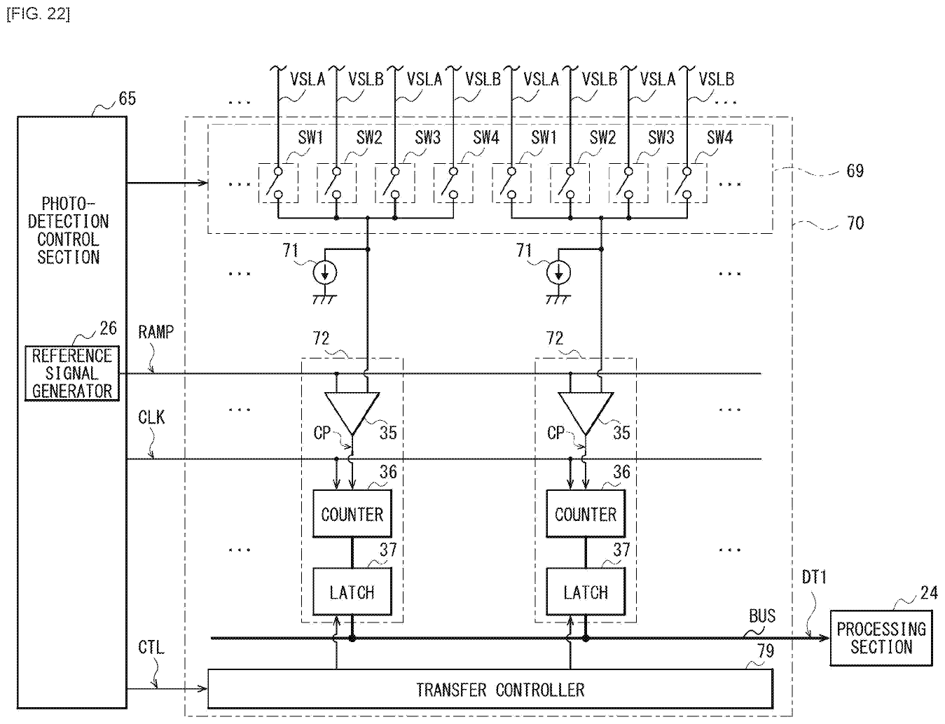

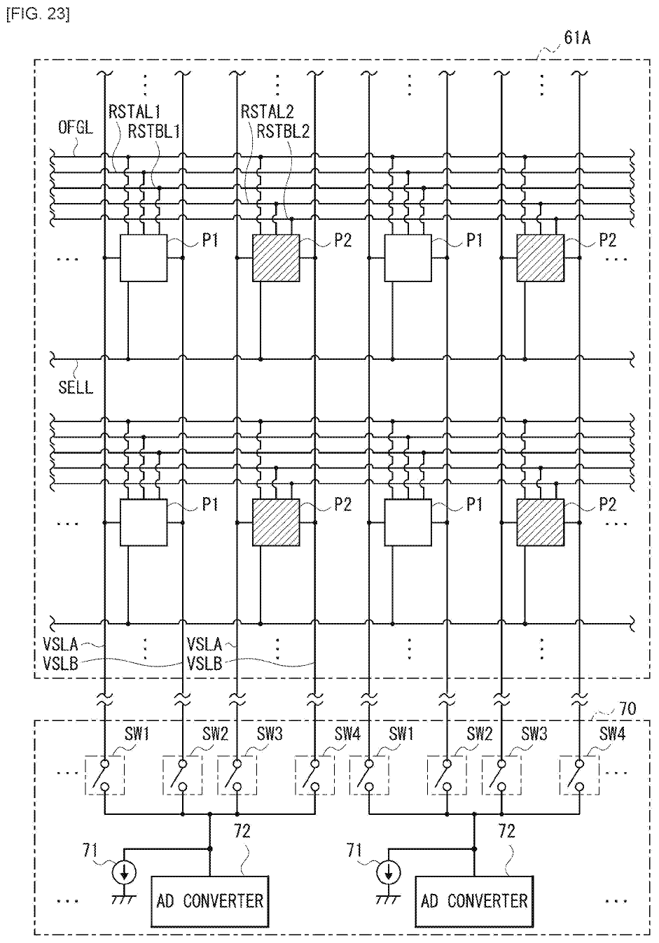

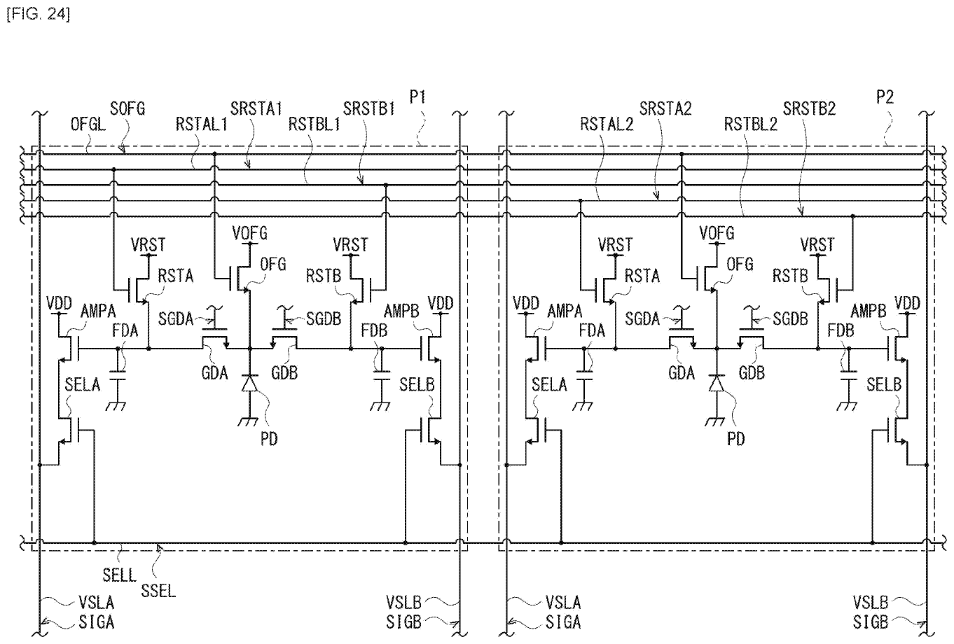

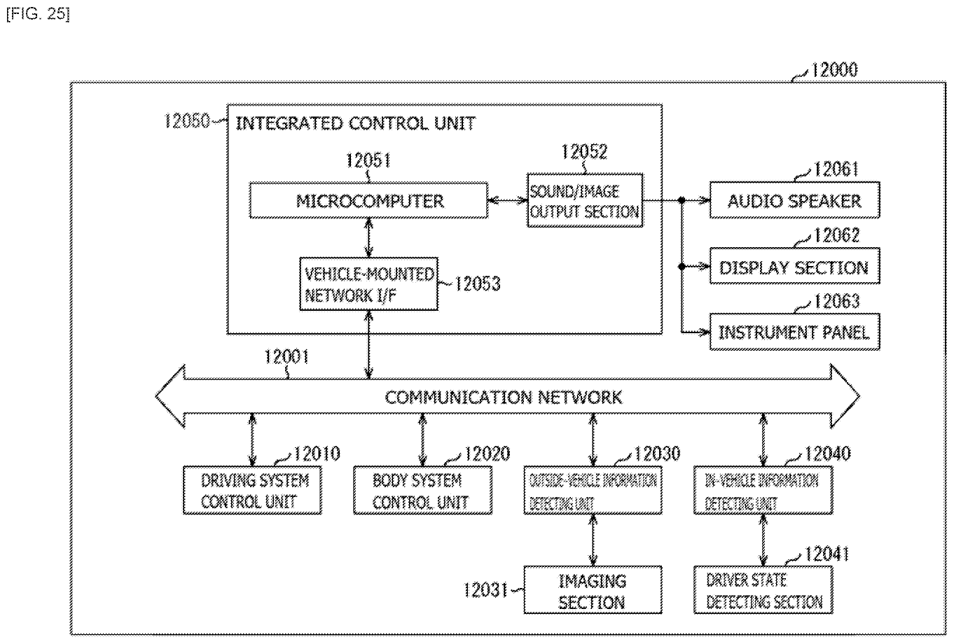

In the embodiment described above, as illustrated in FIG. 21, the transistors FDGA and FDGB and the floating diffusions FDA2 and FDB2 are provided to make it possible to change a conversion gain of converting electric charge into a voltage in the light-receiving pixel P. However, this is not limitative. Alternatively, the transistors FDGA and FDGB and the floating diffusions FDA2 and FDB2 may not be provided, as in a pixel array 61A illustrated in FIGS. 23 and 24. The pixel array 61A includes the plurality of control lines OFGL, the plurality of control lines RSTAL1, the plurality of control lines RSTBL1, the plurality of control lines RSTAL2, the plurality of control lines RSTBL2, the plurality of control lines SELL, the plurality of signal lines VSLA, and the plurality of signal lines VSLB. The light-receiving pixel P1 is coupled to the control lines OFGL, RSTAL1, RSTBL1, and SELL and the signal lines VSLA and VSLB. The light-receiving pixel P2 is coupled to the control lines OFGL, RSTAL2, RSTBL2, and SELL and the signal lines VSLA and VSLB.

### 4. Example of Application to Mobile Body

The technology (the present technology) according to the present disclosure is applicable to a variety of products. For example, the technology according to the present disclosure may be achieved as an apparatus to be installed aboard any type of mobile body such as an automobile, an electric vehicle, a hybrid electric vehicle, a motorcycle, a bicycle, a personal mobility, an airplane, a drone, a vessel, or a robot.

FIG. 25 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 25, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 25, an audio speaker 12061, a display section 12062, and an instrument panel 12063 are illustrated as the output device. The display section 12062 may, for example, include at least one of an on-board display and a head-up display.

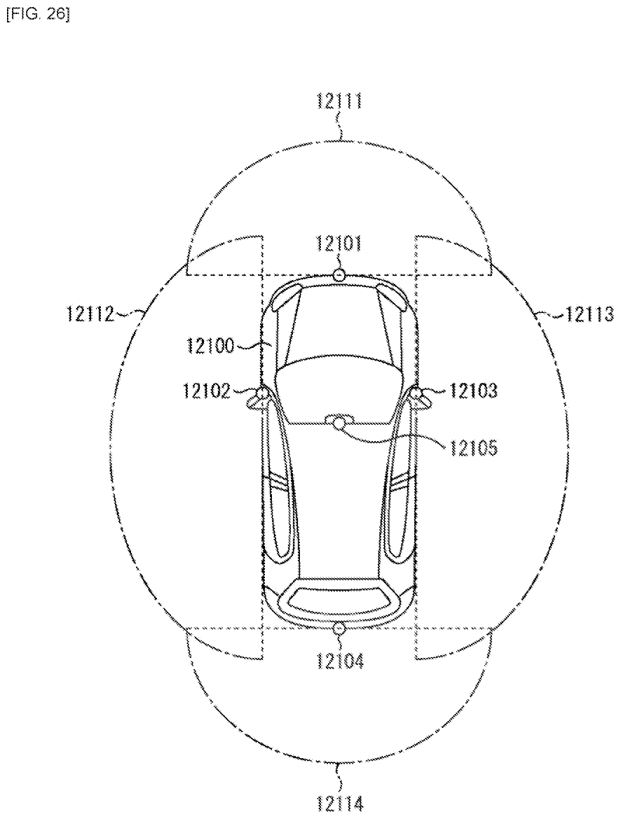

FIG. 26 is a diagram depicting an example of the installation position of the imaging section 12031.

In FIG. 26, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 26 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure is applicable has been described above. The technology according to the present disclosure is applicable to the imaging section 12031 among the above-described components. This makes it possible, in the vehicle control system 12000, to reduce the size of the imaging section 12031 or to reduce the cost, for example. Furthermore, increasing the number of the light-receiving pixels P by utilizing the reduced circuit area makes it possible to increase the resolution of a distance image, for example. As a result, it is possible for the vehicle control system 12000 to achieve, with high accuracy, a collision avoidance or collision mitigation function for the vehicle, a following driving function based on vehicle-to-vehicle distance, a vehicle speed maintaining driving function, a warning function against collision of the vehicle, a warning function against deviation of the vehicle from a lane, and the like.

Although the present technology has been described above with reference to the embodiments, the modification examples, and the specific application example thereof, the present technology is not limited to the embodiment and the like, and may be modified in a wide variety of ways.

For example, although the light-receiving pixels P as illustrated in FIGS. 4 and 21 are provided in the embodiments described above, for example, the circuit configuration of the light-receiving pixels P is not limited thereto, and various types of circuit configurations are applicable.

It is to be noted that the effects described in the present specification are merely exemplary and non-limiting, and other effects may also be achieved.

It is to be noted that the present technology may have the following configurations. According to the technology of the following configurations, it is possible to reduce a circuit area.

(1)

A photodetector including:
a first light-receiving pixel and a second light-receiving pixel arranged side by side in a first direction;
a first signal line and a second signal line extending in a second direction that differs from the first direction and being coupled to the first light-receiving pixel;
a third signal line and a fourth signal line extending in the second direction and being coupled to the second light-receiving pixel;
a first control line and a second control line extending in the first direction, the first control line being coupled to the first light-receiving pixel, the second control line being coupled to the second light-receiving pixel; and
a first control circuit configured to control operations of the first light-receiving pixel and the second light-receiving pixel via the first control line and the second control line,
the first light-receiving pixel and the second light-receiving pixel each including
   a light-receiving element configured to generate electric charge on a basis of light,
   a first accumulation element and a second accumulation element that are configured to accumulate the electric charge,
   a first transfer transistor configured to couple the light-receiving element and the first accumulation element to each other upon coming into an on state,
   a second transfer transistor configured to couple the light-receiving element and the second accumulation element to each other upon coming into an on state,
   a first control transistor configured to apply a predetermined voltage to the first accumulation element upon coming into an on state,
   a second control transistor configured to apply the predetermined voltage to the second accumulation element upon coming into an on state,
   a first output circuit configured to output a voltage corresponding to a voltage in the first accumulation element, and
   a second output circuit configured to output a voltage corresponding to a voltage in the second accumulation element, in which
gates of the first control transistor and the second control transistor in the first light-receiving pixel are coupled to the first control line,
the first output circuit and the second output circuit in the first light-receiving pixel are respectively coupled to the first signal line and the second signal line,
gates of the first control transistor and the second control transistor in the second light-receiving pixel are coupled to the second control line, and
the first output circuit and the second output circuit in the second light-receiving pixel are respectively coupled to the third signal line and the fourth signal line.
   (2)

The photodetector according to (1), in which
the first control circuit is configured to bring, in a first period, the first control transistor and the second control transistor in the first light-receiving pixel each into an on state, and
the first control circuit is configured to bring, in a second period, the first control transistor and the second control transistor in the second light-receiving pixel each into an on state.
   (3)

The photodetector according to (2), further including:
a first conversion circuit and a second conversion circuit that are configured to perform AD conversion operation;
a first switch configured to couple the first signal line to the first conversion circuit upon coming into an on state;
a second switch configured to couple the second signal line to the second conversion circuit upon coming into an on state;
a third switch configured to couple the third signal line to the first conversion circuit upon coming into an on state;
a fourth switch configured to couple the fourth signal line to the second conversion circuit upon coming into an on state; and
a second control circuit configured to bring, in a first operation period, the first switch and the second switch each into an on state and to bring, in a second operation period, the third switch and the fourth switch each into an on state.
   (4)

The photodetector according to (3), further including a processing section, in which
the first light-receiving pixel and the second light-receiving pixel are configured to detect a light pulse reflected by a detection target among light pulses emitted from a light-emitting section,
the first control circuit is further configured to control operations of the first transfer transistor and the second transfer transistor in accordance with an operation of the light-emitting section,
the processing section is configured to calculate a first time of flight of the light pulse detected in the first light-receiving pixel on a basis of a first conversion result of the first conversion circuit and a second conversion result of the second conversion circuit in the first operation period, and
the processing section is configured to calculate a second time of flight of the light pulse detected in the second light-receiving pixel on a basis of a third conversion result of the first conversion circuit and a fourth conversion result of the second conversion circuit in the second operation period.
   (5)

The photodetector according to (4), in which
the processing section is configured to calculate the first time of flight further on a basis of the third conversion result and the fourth conversion result, in addition to the first conversion result and the second conversion result, and
the processing section is configured to calculate the second time of flight further on a basis of the first conversion result and the second conversion result, in addition to the third conversion result and the fourth conversion result.
   (6)

The photodetector according to (1), in which the first control circuit is configured to bring, in a third period, the first control transistor and the second control transistor in the first light-receiving pixel and the first control transistor and the second control transistor in the second light-receiving pixel each into an on state.

(7)

The photodetector according to (6), further including:
a first conversion circuit and a second conversion circuit that are configured to perform AD conversion operation;
a first switch configured to couple the first signal line to the first conversion circuit upon coming into an on state;
a second switch configured to couple the second signal line to the second conversion circuit upon coming into an on state;
a third switch configured to couple the third signal line to the first conversion circuit upon coming into an on state;
a fourth switch configured to couple the fourth signal line to the second conversion circuit upon coming into an on state; and
a second control circuit configured to bring, in a third operation period, the first switch, the second switch, the third switch, and the fourth switch each into an on state.
   (8)

The photodetector according to (1), in which
the first control line includes two control lines,
the gate of the first control transistor and the gate of the second control transistor in the first light-receiving pixel are respectively coupled to the two control lines included in the first control line,
the second control line includes two control lines,
the gate of the first control transistor and the gate of the second control transistor in the second light-receiving pixel are respectively coupled to the two control lines included in the second control line, and
the first control circuit is configured to bring the first control transistor in the first light-receiving pixel, the second control transistor in the first light-receiving pixel, the first control transistor in the second light-receiving pixel, and the second control transistor in the second light-receiving pixel each into an on state sequentially in periods that differ from each other.
   (9)

The photodetector according to (8), further including:
a conversion circuit configured to perform AD conversion operation;
a first switch configured to couple the first signal line to the conversion circuit upon coming into an on state;
a second switch configured to couple the second signal line to the conversion circuit upon coming into an on state;
a third switch configured to couple the third signal line to the conversion circuit upon coming into an on state;
a fourth switch configured to couple the fourth signal line to the conversion circuit upon coming into an on state; and
a second control circuit configured to bring the first switch, the second switch, the third switch, and the fourth switch each into an on state sequentially in periods that differ from each other.
   (10)

The photodetector according to any one of (1) to (9), further including a third control line and a fourth control line extending in the first direction, the third control line being coupled to the first light-receiving pixel, the fourth control line being coupled to the second light-receiving pixel,
the first light-receiving pixel and the second light-receiving pixel each further including
   a third accumulation element and a fourth accumulation element that are configured to accumulate the electric charge,
   a third control transistor configured to couple the first accumulation element and the third accumulation element to each other upon coming into an on state, and
   a fourth control transistor configured to couple the second accumulation element and the fourth accumulation element to each other upon coming into an on state, in which
gates of the third control transistor and the fourth control transistor in the first light-receiving pixel are coupled to the third control line, and
gates of the third control transistor and the fourth control transistor in the second light-receiving pixel are coupled to the fourth control line.
   (11)

A photodetection system including:
a light-emitting section configured to emit light pulses;
a first light-receiving pixel and a second light-receiving pixel arranged side by side in a first direction, the first light-receiving pixel and the second light-receiving pixel each being configured to detect a light pulse reflected by a detection target among the light pulses emitted from the light-emitting section;
a first signal line and a second signal line extending in a second direction that differs from the first direction and being coupled to the first light-receiving pixel;
a third signal line and a fourth signal line extending in the second direction and being coupled to the second light-receiving pixel;
a first control line and a second control line extending in the first direction, the first control line being coupled to the first light-receiving pixel, the second control line being coupled to the second light-receiving pixel; and
a first control circuit configured to control operations of the first light-receiving pixel and the second light-receiving pixel via the first control line and the second control line,
the first light-receiving pixel and the second light-receiving pixel each including
   a light-receiving element configured to generate electric charge on a basis of light,
   a first accumulation element and a second accumulation element that are configured to accumulate the electric charge,
   a first transfer transistor configured to couple the light-receiving element and the first accumulation element to each other upon coming into an on state,
   a second transfer transistor configured to couple the light-receiving element and the second accumulation element to each other upon coming into an on state,
   a first control transistor configured to apply a predetermined voltage to the first accumulation element upon coming into an on state,
   a second control transistor configured to apply the predetermined voltage to the second accumulation element upon coming into an on state,
   a first output circuit configured to output a voltage corresponding to a voltage in the first accumulation element, and
   a second output circuit configured to output a voltage corresponding to a voltage in the second accumulation element, in which
gates of the first control transistor and the second control transistor in the first light-receiving pixel are coupled to the first control line,
the first output circuit and the second output circuit in the first light-receiving pixel are respectively coupled to the first signal line and the second signal line,
gates of the first control transistor and the second control transistor in the second light-receiving pixel are coupled to the second control line, and
the first output circuit and the second output circuit in the second light-receiving pixel are respectively coupled to the third signal line and the fourth signal line.
   (12)

A photodetection method including:
bringing, in a first period, a first control transistor and a second control transistor in a first light-receiving pixel each into an on state in a photodetector; and
bringing, in a second period, a first control transistor and a second control transistor in a second light-receiving pixel each into an on state in the photodetector,
the photodetector including
   the first light-receiving pixel and the second light-receiving pixel arranged side by side in a first direction,
   a first signal line and a second signal line extending in a second direction that differs from the first direction and being coupled to the first light-receiving pixel,
   a third signal line and a fourth signal line extending in the second direction and being coupled to the second light-receiving pixel, and
   a first control line and a second control line extending in the first direction, the first control line being coupled to the first light-receiving pixel, the second control line being coupled to the second light-receiving pixel,
   the first light-receiving pixel and the second light-receiving pixel each including
      a light-receiving element configured to generate electric charge on a basis of light,
      a first accumulation element and a second accumulation element that are configured to accumulate the electric charge,
      a first transfer transistor configured to couple the light-receiving element and the first accumulation element to each other upon coming into an on state,
      a second transfer transistor configured to couple the light-receiving element and the second accumulation element to each other upon coming into an on state,
      the first control transistor configured to apply a predetermined voltage to the first accumulation element upon coming into an on state,
      the second control transistor configured to apply the predetermined voltage to the second accumulation element upon coming into an on state,
      a first output circuit configured to output a voltage corresponding to a voltage in the first accumulation element, and
      a second output circuit configured to output a voltage corresponding to a voltage in the second accumulation element, in which
   gates of the first control transistor and the second control transistor in the first light-receiving pixel are coupled to the first control line,
   the first output circuit and the second output circuit in the first light-receiving pixel are respectively coupled to the first signal line and the second signal line,
   gates of the first control transistor and the second control transistor in the second light-receiving pixel are coupled to the second control line, and
   the first output circuit and the second output circuit in the second light-receiving pixel are respectively coupled to the third signal line and the fourth signal line.
      (13)

The photodetection method according to (12), further including:
coupling, in a first operation period, the first signal line to a first conversion circuit configured to perform AD conversion operation and coupling the second signal line to a second conversion circuit configured to perform AD conversion operation; and
coupling, in a second operation period, the third signal line to the first conversion circuit and coupling the fourth signal line to the second conversion circuit.

The present application claims the benefit of Japanese Priority Patent Application JP2021-083436 filed with the Japan Patent Office on May 17, 2021, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A photodetector comprising:
a first light-receiving pixel and a second light-receiving pixel arranged side by side in a first direction;
a first signal line and a second signal line extending in a second direction that differs from the first direction and being coupled to the first light-receiving pixel;
a third signal line and a fourth signal line extending in the second direction and being coupled to the second light-receiving pixel;
a first control line and a second control line extending in the first direction, the first control line being coupled to the first light-receiving pixel, the second control line being coupled to the second light-receiving pixel; and
a first control circuit configured to control operations of the first light-receiving pixel and the second light-receiving pixel via the first control line and the second control line,
the first light-receiving pixel and the second light-receiving pixel each including
a light-receiving element configured to generate electric charge on a basis of light,
a first accumulation element and a second accumulation element that are configured to accumulate the electric charge,
a first transfer transistor configured to couple the light-receiving element and the first accumulation element to each other upon coming into an on state,
a second transfer transistor configured to couple the light-receiving element and the second accumulation element to each other upon coming into an on state,
a first control transistor configured to apply a predetermined voltage to the first accumulation element upon coming into an on state,
a second control transistor configured to apply the predetermined voltage to the second accumulation element upon coming into an on state,
a first output circuit configured to output a voltage corresponding to a voltage in the first accumulation element, and
a second output circuit configured to output a voltage corresponding to a voltage in the second accumulation element, wherein
gates of the first control transistor and the second control transistor in the first light-receiving pixel are coupled to the first control line,
the first output circuit and the second output circuit in the first light-receiving pixel are respectively coupled to the first signal line and the second signal line,
gates of the first control transistor and the second control transistor in the second light-receiving pixel are coupled to the second control line, and
the first output circuit and the second output circuit in the second light-receiving pixel are respectively coupled to the third signal line and the fourth signal line.

2. The photodetector according to claim 1, wherein
the first control circuit is configured to bring, in a first period, the first control transistor and the second control transistor in the first light-receiving pixel each into an on state, and
the first control circuit is configured to bring, in a second period, the first control transistor and the second control transistor in the second light-receiving pixel each into an on state.

3. The photodetector according to claim 2, further comprising:
a first conversion circuit and a second conversion circuit that are configured to perform AD conversion operation;
a first switch configured to couple the first signal line to the first conversion circuit upon coming into an on state;
a second switch configured to couple the second signal line to the second conversion circuit upon coming into an on state;
a third switch configured to couple the third signal line to the first conversion circuit upon coming into an on state;
a fourth switch configured to couple the fourth signal line to the second conversion circuit upon coming into an on state; and
a second control circuit configured to bring, in a first operation period, the first switch and the second switch each into an on state and to bring, in a second operation period, the third switch and the fourth switch each into an on state.

4. The photodetector according to claim 3, further comprising a processing section, wherein
the first light-receiving pixel and the second light-receiving pixel are configured to detect a light pulse reflected by a detection target among light pulses emitted from a light-emitting section,
the first control circuit is further configured to control operations of the first transfer transistor and the second transfer transistor in accordance with an operation of the light-emitting section,
the processing section is configured to calculate a first time of flight of the light pulse detected in the first light-receiving pixel on a basis of a first conversion result of the first conversion circuit and a second conversion result of the second conversion circuit in the first operation period, and
the processing section is configured to calculate a second time of flight of the light pulse detected in the second light-receiving pixel on a basis of a third conversion result of the first conversion circuit and a fourth conversion result of the second conversion circuit in the second operation period.

5. The photodetector according to claim 4, wherein
the processing section is configured to calculate the first time of flight further on a basis of the third conversion result and the fourth conversion result, in addition to the first conversion result and the second conversion result, and
the processing section is configured to calculate the second time of flight further on a basis of the first conversion result and the second conversion result, in addition to the third conversion result and the fourth conversion result.

6. The photodetector according to claim 1, wherein the first control circuit is configured to bring, in a third period, the first control transistor and the second control transistor in the first light-receiving pixel and the first control transistor and the second control transistor in the second light-receiving pixel each into an on state.

7. The photodetector according to claim 6, further comprising:
a first conversion circuit and a second conversion circuit that are configured to perform AD conversion operation;
a first switch configured to couple the first signal line to the first conversion circuit upon coming into an on state;
a second switch configured to couple the second signal line to the second conversion circuit upon coming into an on state;
a third switch configured to couple the third signal line to the first conversion circuit upon coming into an on state;
a fourth switch configured to couple the fourth signal line to the second conversion circuit upon coming into an on state; and
a second control circuit configured to bring, in a third operation period, the first switch, the second switch, the third switch, and the fourth switch each into an on state.

8. The photodetector according to claim 1, wherein
the first control line includes two control lines,
the gate of the first control transistor and the gate of the second control transistor in the first light-receiving pixel are respectively coupled to the two control lines included in the first control line,
the second control line includes two control lines,
the gate of the first control transistor and the gate of the second control transistor in the second light-receiving pixel are respectively coupled to the two control lines included in the second control line, and
the first control circuit is configured to bring the first control transistor in the first light-receiving pixel, the second control transistor in the first light-receiving pixel, the first control transistor in the second light-receiving pixel, and the second control transistor in the second light-receiving pixel each into an on state sequentially in periods that differ from each other.

9. The photodetector according to claim 8, further comprising:
a conversion circuit configured to perform AD conversion operation;
a first switch configured to couple the first signal line to the conversion circuit upon coming into an on state;
a second switch configured to couple the second signal line to the conversion circuit upon coming into an on state;
a third switch configured to couple the third signal line to the conversion circuit upon coming into an on state;
a fourth switch configured to couple the fourth signal line to the conversion circuit upon coming into an on state; and
a second control circuit configured to bring the first switch, the second switch, the third switch, and the fourth switch each into an on state sequentially in periods that differ from each other.

10. The photodetector according to claim 1, further comprising a third control line and a fourth control line extending in the first direction, the third control line being coupled to the first light-receiving pixel, the fourth control line being coupled to the second light-receiving pixel,
the first light-receiving pixel and the second light-receiving pixel each further including
a third accumulation element and a fourth accumulation element that are configured to accumulate the electric charge,
a third control transistor configured to couple the first accumulation element and the third accumulation element to each other upon coming into an on state, and
a fourth control transistor configured to couple the second accumulation element and the fourth accumulation element to each other upon coming into an on state, wherein
gates of the third control transistor and the fourth control transistor in the first light-receiving pixel are coupled to the third control line, and
gates of the third control transistor and the fourth control transistor in the second light-receiving pixel are coupled to the fourth control line.

11. A photodetection system comprising:
a light-emitting section configured to emit light pulses;
a first light-receiving pixel and a second light-receiving pixel arranged side by side in a first direction, the first light-receiving pixel and the second light-receiving pixel each being configured to detect a light pulse reflected by a detection target among the light pulses emitted from the light-emitting section;
a first signal line and a second signal line extending in a second direction that differs from the first direction and being coupled to the first light-receiving pixel;
a third signal line and a fourth signal line extending in the second direction and being coupled to the second light-receiving pixel;
a first control line and a second control line extending in the first direction, the first control line being coupled to the first light-receiving pixel, the second control line being coupled to the second light-receiving pixel; and
a first control circuit configured to control operations of the first light-receiving pixel and the second light-receiving pixel via the first control line and the second control line,
the first light-receiving pixel and the second light-receiving pixel each including
a light-receiving element configured to generate electric charge on a basis of light,
a first accumulation element and a second accumulation element that are configured to accumulate the electric charge,
a first transfer transistor configured to couple the light-receiving element and the first accumulation element to each other upon coming into an on state,
a second transfer transistor configured to couple the light-receiving element and the second accumulation element to each other upon coming into an on state,
a first control transistor configured to apply a predetermined voltage to the first accumulation element upon coming into an on state,
a second control transistor configured to apply the predetermined voltage to the second accumulation element upon coming into an on state,
a first output circuit configured to output a voltage corresponding to a voltage in the first accumulation element, and
a second output circuit configured to output a voltage corresponding to a voltage in the second accumulation element, wherein
gates of the first control transistor and the second control transistor in the first light-receiving pixel are coupled to the first control line,
the first output circuit and the second output circuit in the first light-receiving pixel are respectively coupled to the first signal line and the second signal line,
gates of the first control transistor and the second control transistor in the second light-receiving pixel are coupled to the second control line, and
the first output circuit and the second output circuit in the second light-receiving pixel are respectively coupled to the third signal line and the fourth signal line.

12. A photodetection method comprising:
bringing, in a first period, a first control transistor and a second control transistor in a first light-receiving pixel each into an on state in a photodetector; and
bringing, in a second period, a first control transistor and a second control transistor in a second light-receiving pixel each into an on state in the photodetector,
the photodetector including
the first light-receiving pixel and the second light-receiving pixel arranged side by side in a first direction,
a first signal line and a second signal line extending in a second direction that differs from the first direction and being coupled to the first light-receiving pixel,
a third signal line and a fourth signal line extending in the second direction and being coupled to the second light-receiving pixel, and
a first control line and a second control line extending in the first direction, the first control line being coupled to the first light-receiving pixel, the second control line being coupled to the second light-receiving pixel,
the first light-receiving pixel and the second light-receiving pixel each including
a light-receiving element configured to generate electric charge on a basis of light,
a first accumulation element and a second accumulation element that are configured to accumulate the electric charge,
a first transfer transistor configured to couple the light-receiving element and the first accumulation element to each other upon coming into an on state,
a second transfer transistor configured to couple the light-receiving element and the second accumulation element to each other upon coming into an on state,
the first control transistor configured to apply a predetermined voltage to the first accumulation element upon coming into an on state,
the second control transistor configured to apply the predetermined voltage to the second accumulation element upon coming into an on state,
a first output circuit configured to output a voltage corresponding to a voltage in the first accumulation element, and
a second output circuit configured to output a voltage corresponding to a voltage in the second accumulation element, wherein
gates of the first control transistor and the second control transistor in the first light-receiving pixel are coupled to the first control line,
the first output circuit and the second output circuit in the first light-receiving pixel are respectively coupled to the first signal line and the second signal line,
gates of the first control transistor and the second control transistor in the second light-receiving pixel are coupled to the second control line, and
the first output circuit and the second output circuit in the second light-receiving pixel are respectively coupled to the third signal line and the fourth signal line.

13. The photodetection method according to claim 12, further comprising:
coupling, in a first operation period, the first signal line to a first conversion circuit configured to perform AD conversion operation and coupling the second signal line to a second conversion circuit configured to perform AD conversion operation; and
coupling, in a second operation period, the third signal line to the first conversion circuit and coupling the fourth signal line to the second conversion circuit.
